(19) United States
(12) Patent Application Publication
(10) Pub. No.: US 2006/0129539 A1
(43) Pub. Date: Jun. 15, 2006

(54) Information processing device and method thereof

(76) Inventor: Masashi Nakatomi, Tokyo (JP)

Correspondence Address: COOPER & DUNHAM, LLP, 1185 AVENUE OF THE AMERICAS, NEW YORK, NY, 10036, US

(21) Appl. No.: 11/297,630

(22) Filed: Dec. 8, 2005

(30) Foreign Application Priority Data
Dec. 9, 2004 (JP) 2004-357163
Oct. 18, 2005 (JP) 2005-303317

(51) Int. Cl. G06F 17/30

(52) U.S. Cl. 707/3

(57) ABSTRACT

An information processing device is disclosed that is of improved operability and is able to efficiently predict operations to be conducted by a user on various kinds of electronic files. The information processing device includes a selection candidate presentation unit for presenting candidates of selection functions when an icon is selected, an electronic file information acquisition unit for acquiring electronic file information, and a storage device which includes a parameter table A, an operations history table B, and an electronic file information table C. Concerning the electronic file selected by the user, the electronic file information acquisition unit obtains the electronic file ID, and the selection candidate presentation unit predicts a number of operations to be executed based on the electronic file information, the parameter table A, and the operations history table B, and presents the selection candidates to the user.

### BACKGROUND OF THE INVENTION

1. Field of the Invention

The present invention relates to an information-processing device that allows a user to select an operation to be executed on an electronic file, and a method of the information-processing device.

2. Description of the Related Art

Various operations can be executed on electronic files stored in a computer. For example, these operations may include copy and transfer of the electronic files between different storage media in the same computer or between different computers, deletion of the electronic files, attachment of the electronic files to an electronic mail for transmission; printing of the electronic files from an application program (below, simply abbreviated as “application”), editing of the electronic files with a document editor, or compression of the electronic files for reducing the size of the electronic files. The operations on the electronic files may further include determination of a destination when transferring the electronic files, determination of a destination when transmitting the electronic mail with the electronic files being attached, or determination of the number of copies when printing the electronic files.

In such a computer system, it is necessary for a user to select a function under a specific situation. When the number of functions to be selected is large, or when the functions become complicated, it becomes troublesome for the user to make such selections.

Some methods have been proposed to make the function selection easy to lessen the burden on the user. One of the methods involves drag and drop of icons on a graphical user interface. Here, “drag and drop” means moving an icon displayed on the screen of the monitor of the computer and representing an electronic file by using a pointing device such as a mouse, and overlapping the icon with another icon on the screen and representing a specific function (below, simply referred to as a “functional icon” where necessary), and thereby, the function is executed very easily.

Another method involves function-selection by a “right-click menu”. Specifically, when a right button of a mouse whose screen pointer is located on an icon is clicked, typical functions allowed to be carried out on that icon are displayed in a menu on the screen of the computer.

However, the above methods suffer from the following problems. In the drag-and-drop method, the number of the functional icons displayed on the screen is limited. In the right-click-menu method, the number of typical functions able to be displayed in the menu is also limited when the right button of the mouse is clicked. Certainly, if the size of the screen is sufficiently large, it is possible to display a large number of functions, but this again makes the user feel troubled to make selections from the large number of candidate functions.

Next, because the functions displayed on the screen are fixed, and include the typical functions frequently used and functions less frequently used, those functions less frequently used are constantly displayed on the screen.

In order to solve these problems, it is necessary to make the displayed functions changeable depending on the conditions of the user. For this purpose, a few methods have been proposed to allow the computer to limit the selection candidates and to display the limited selection candidates.

For example, reference can be made to Japanese Laid-Open Patent Application No. 7-306847, Japanese Laid-Open Patent Application No. 2004-102935, Japanese Laid-Open Patent Application No. 8-101766, and Japanese Laid-Open Patent Application No. 2000-259658.

The document classification device of the related art, however, is designed to deal with only text documents, but is not applicable to image files or other kinds of electronic files. That is to say, the document classification device is not able to determine the similarity between electronic files of any formats, and thus cannot predict the next operation from the similarity.

### SUMMARY OF THE INVENTION

It is a general object of the present invention to solve one or more problems of the related art.

A specific object of the present invention is to provide an information processing device of improved operability and able to efficiently predict operations to be conducted by a user when handling not only a text electronic file but also other kinds of electronic files.

According to the present invention, there is provided an information processing device, comprising: an electronic file information acquisition unit configured to acquire information of an electronic file; a history information acquisition unit configured to acquire operation history information including information of operations previously performed on the electronic file; a weight factor acquisition unit configured to acquire weight factors assigned to a plurality of parameters of the electronic file information; and a prediction unit configured to predict an operation to be executed on the electronic file based on the electronic file information, the operation history information, and the weight factors.

According to the present invention, it is possible to provide an information processing device of improved operability and able to efficiently predict operations to be conducted by a user when handling not only a text electronic file but also other kinds of electronic files.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a block diagram illustrating an example of a hardware configuration of an information-processing device 100 according to a first embodiment of the present invention;

FIG. 2 is a diagram illustrating examples of operations performed by the information processing device 100 on one electronic file;

FIG. 3 is a diagram illustrating an example of function candidates presented by the information-processing device 100 of the present embodiment;

FIG. 4 is a block diagram illustrating an example of a configuration of the information-processing device 100 of the present embodiment;

FIG. 5 is a flowchart illustrating an example of operations of the information processing device 100 of the first embodiment;

FIG. 6 illustrates an example of the operations history table B;

FIG. 7 illustrates an example of the parameter table A;

FIG. 8 illustrates an example of the electronic file information table C;

FIG. 9 is a flowchart illustrating an example of operations of the selection candidate presentation unit 122 in the information processing device 100;

FIG. 10 is a flowchart illustrating an example of operations of the electronic file information acquisition unit 123 in the information processing device 100;

FIG. 11 is a flowchart illustrating an example of operations of the history updating unit 124 in the information processing device 100;

FIG. 12 is a flowchart illustrating an example of operations of the parameter updating unit 127 when the selection detection unit 121 detects that the user selected a function e_{select};

FIG. 13 shows examples of settings displayed on a screen for forming an image by using a printer;

FIG. 14 show other examples of settings displayed on a screen for forming an image by using a printer;

FIG. 15 is a block diagram illustrating an example of a configuration of an information processing device 200 of the present embodiment;

FIG. 16 is a table exemplifying the image setting candidate table D;

FIG. 17 is a table exemplifying the image setting selection table E;

FIG. 18 is a block diagram illustrating an example of a configuration of the information processing device for reproducing data in a medium on the display, as another example the present embodiment;

FIG. 19 illustrates the initial state of a printer driver, as another example of the information processing device of the present embodiment;

FIG. 20 shows the state of the printer driver after the function selection is modified;

FIG. 21 illustrates a printer 11 which includes a storage unit, as another example of the information processing device of the present embodiment.

FIG. 22 is a table showing symbols of the nine attributes used in analysis;

FIG. 23 is a diagram showing the Cramer's values representing the correlations between every two of the nine attributes as shown in FIG. 22;

FIG. 24A is a table showing the correlation between the attribute of the collective printing (PPS) and the attribute of the number of pages of the manuscript (NPD);

FIG. 24B is a table showing the correlation between the attribute of the collective printing (PPS) and the attribute of the extension (EXT);

FIG. 25A is a diagram showing the Cramer's values at 10% from the top in the corresponding distributions of the Cramer's values for different users;

FIG. 25B is a diagram showing the Cramer's values at 20% from the top in the corresponding distributions of the Cramer's values for different users;

FIG. 26A through 26K are histograms illustrate distributions of the Cramer's values of the above 11 pairs of attributes to confirm existence of correlations therebetween;

FIG. 27A and FIG. 27B are tables showing the examples of correlations between the attribute of the collective printing (PPS) and the attribute of the extension (EXT) for specific users;

FIG. 28A and FIG. 28B are tables showing examples of correlations between the attribute of double-side printing (DUAL) and the attribute of the extension (EXT) for specific users;

FIG. 29 is a table showing examples of changes of the Cramer's value between the attribute of the medium size (MS) and the attribute of the extension (EXT) along with months for three users X, Y, and Z;

FIG. 30A and FIG. 30B are tables showing specific data of the user X in September and December, respectively; and

FIG. 31 is a flowchart illustrating another example of operations of the information processing device 100 of the first embodiment.

### DESCRIPTION OF THE PREFERRED EMBODIMENTS

Below, preferred embodiments of the present invention are explained with reference to the accompanying drawings.

### First Embodiment

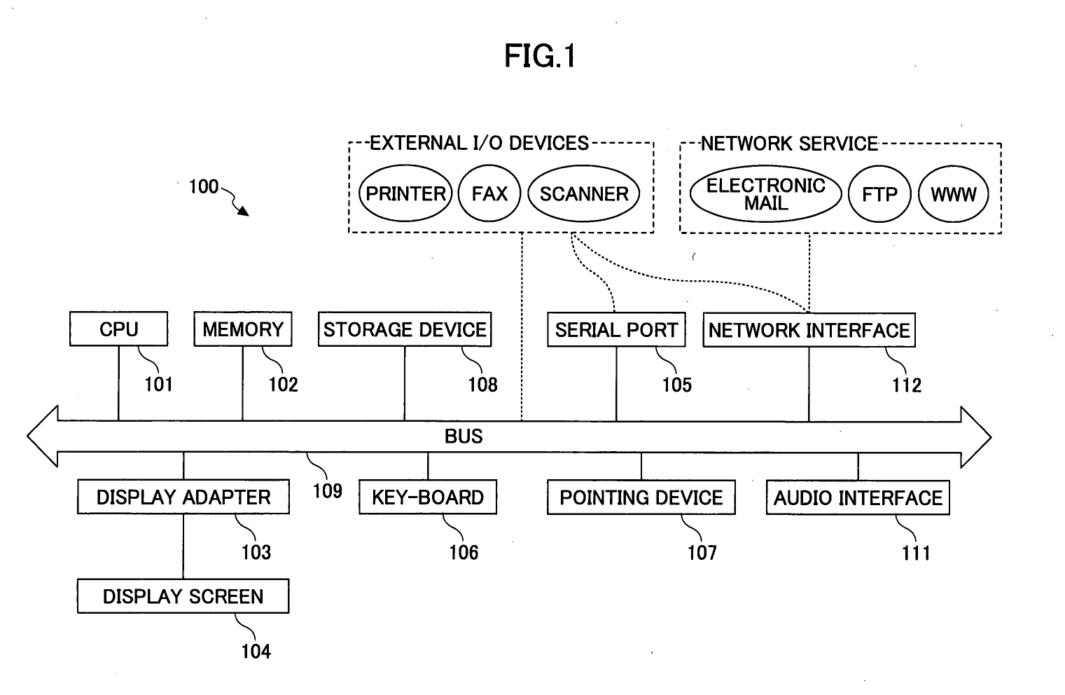

FIG. 1 is a block diagram illustrating an example of a hardware configuration of an information processing device 100 according to a first embodiment of the present invention.

For example, the information processing device 100 is a personal computer or an embedded computer.

As illustrated in FIG. 1, the information processing device 100 includes a bus 109 connecting a CPU 101, a memory 102, and a storage device 108 such as a hard disk.

The information processing device 100 may be connected to various devices, such as a display screen 104 through a display adapter 103, a serial port 105, a key-board 106, a pointing device 107 such as a mouse, an audio interface 111, and a network interface 112. For example, through the network interface 112, the information processing device 100 can receive network services such as WWW (World Wide Web), and the electronic file transfer service like electronic mail or FTP (File Transfer Protocol). Additionally, the information processing device 100 can utilize a printer, or a facsimile machine, or other external input/output apparatuses through the bus 109, the serial port 105, or the network interface 112.

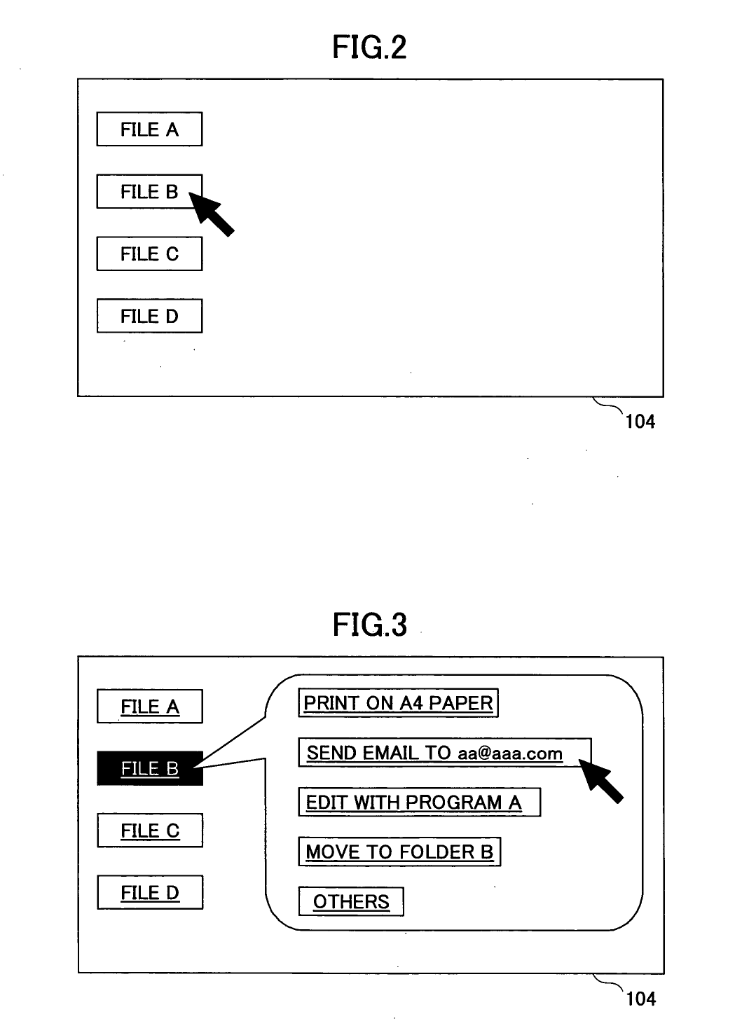

FIG. 2 and FIG. 3 illustrate electronic files A, B, C, and D stored in a personal computer, which are handled by the information processing device 100 of the present embodiment.

Specifically, FIG. 2 is a diagram illustrating examples of operations performed by the information processing device 100 on one electronic file. Here, it is assumed that the information processing device 100 displays icons each representing one electronic file on the display screen 104.

For example, shown in FIG. 2 is a list of icons of the electronic files A, B, C, and D located in a folder in a hard-disk or other media. With the pointing device 107 pointing to an icon “file B”, that is, pointing to the electronic file B, when a button of the pointing device 107 is clicked, such as a mouse having three buttons, and a user is to execute an operation on the electronic file B, the information processing device 100 predicts the operation to be executed on the electronic file B.

FIG. 3 is a diagram illustrating an example of selectable function candidates presented by the information processing device 100 of the present embodiment.

Shown in FIG. 3 are the operations predicted by the information processing device 100. As shown in FIG. 3, prediction results by the information processing device 100 are displayed in a separate menu on the window, and from the predicted operation candidate list, a user is allowed to select an operation to be executed, and in this way, the user can process the electronic file B conveniently.

In addition to the above example, the information processing device 100 may also perform the prediction at different timings. For example, the prediction can be performed when an icon representing an electronic file is dragged and dropped on another icon representing a specific function. Specifically, in the drag and drop operation, with an arrow (pointer) on the icon representing an electronic file, a button of the pointing device 107 is clicked, and with the button of the pointing device 107 being push down, the icon representing an electronic file is moved to the target functional icon by operating the pointing device 107, and is overlapped on the target functional icon; then, the pressed-down button of the pointing device 107 is released.

In addition, the information processing device 100 may also perform the prediction at still other timings. For example, the prediction can be performed when an icon of an electronic file on the display screen 104 is selected by clicking a button of the pointing device 107, and under this condition, a button of the pointing device 107 for displaying operation candidates is clicked.

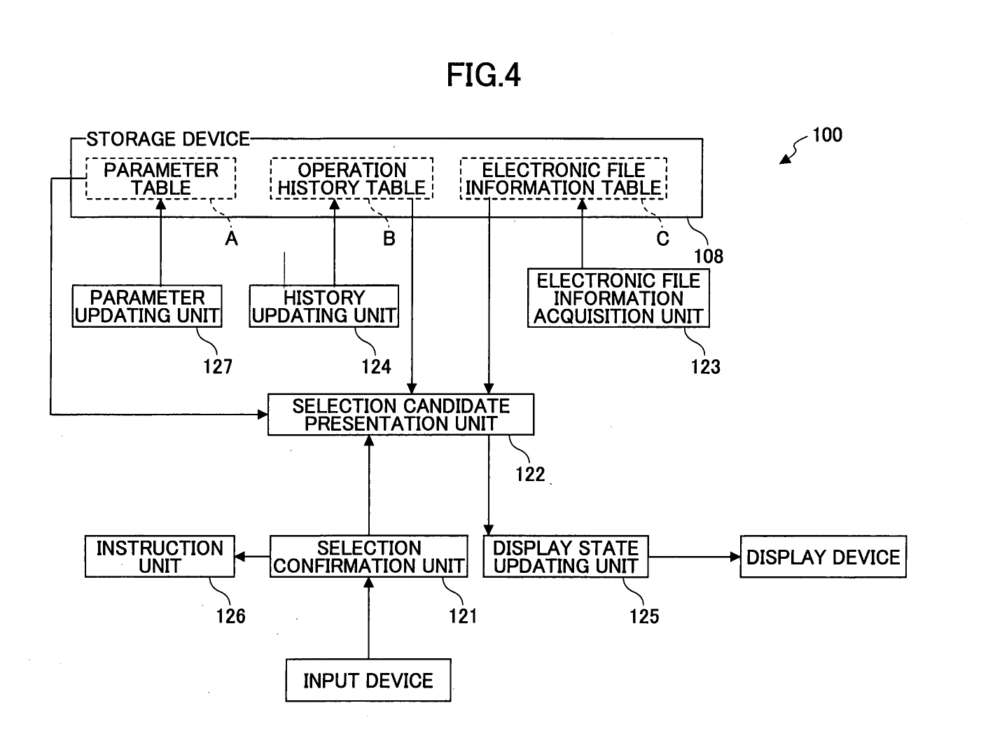

FIG. 4 is a block diagram illustrating an example of a configuration of the information processing device 100 of the present embodiment.

As illustrated in FIG. 4, the information processing device 100 includes a selection detection unit 121 which determines whether an icon on the display screen 104 is selected by using the pointing device 107, a selection candidate presentation unit 122 which presents candidates of selectable functions when an icon is selected, an electronic file information acquisition unit 123 which acquires information of the electronic file represented by the selected icon, a history updating unit 124 which stores types of operations executed on the electronic file together with the information of the electronic file as operations history, a display state updating unit 125 which determines the display format of the display screen 104, an instruction unit 126 which issues instructions for executing the selected function, and a parameter updating unit 127 which updates a parameter table A when the selection detection unit 121 detects that the user has selected a certain function.

For example, these units can be implemented to be a module of programs executed by the CPU 101.

In the storage device 108, there are stored the parameter table A for storing parameters used for representing the candidates, an operations history table B for storing the history of operations executed previously, and an electronic file information table C for storing the information of the electronic file on which the selected operation is to be executed.

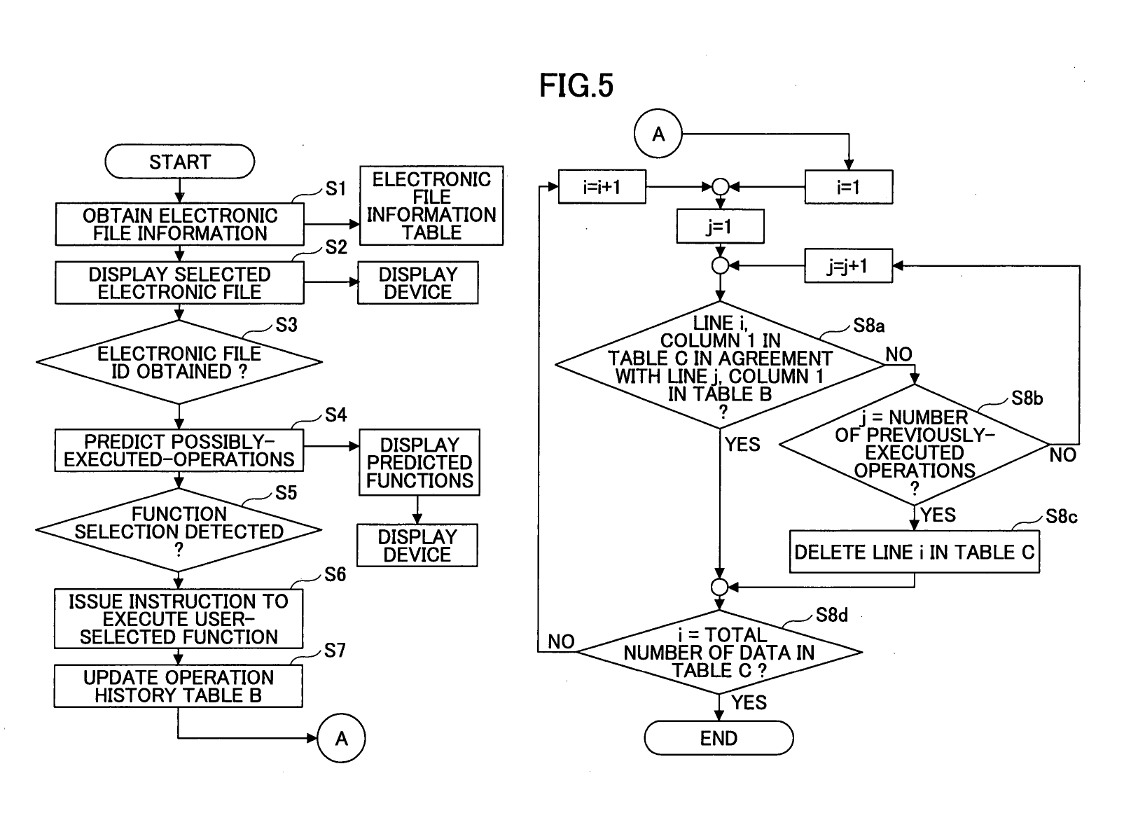

FIG. 5 is a flowchart illustrating an example of operations of the information processing device 100 of the first embodiment.

In step S1, when the selection detection unit 121 determines an icon representing an electronic file is selected, the electronic file information acquisition unit 123 determines whether an electronic file ID of the electronic file corresponding to the selected icon exists in the electronic file information table C, and if the electronic file ID of the electronic file corresponding to the selected icon exists in the electronic file information table C, the electronic file information acquisition unit 123 obtains the electronic file ID.

If the electronic file ID of the electronic file corresponding to the selected icon does not exist in the electronic file information table C, a new electronic file ID is assigned, and the newly assigned electronic file ID is written in the electronic file information table C. Note that the newly assigned electronic file ID should be different from existing electronic file IDs.

In step S2, the display state updating unit 125 displays the selected icon representing the electronic file (below, referred to as “electronic file icon”) on the display screen 104. Here, for example, an electronic file icon is a pictorial image with a file name character string thereon, which is displayed on the display screen 104 for selecting electronic files. For example, when an icon is selected, the program of an application for processing the electronic file is started, and a manual for using the application is displayed.

It should be noted that the electronic file icon is not limited to an icon of an electronic file. For example, the electronic file icon may be an icon of a folder for storing electronic files.

In step S3, when one electronic file is selected by clicking a mouse, or by a cursor on the key board 106, or by a touch panel, the selection detection unit 121 obtains the electronic file ID of the electronic file represented by the electronic file icon selected by the user.

In step S4, once the electronic file icon is selected, the selection candidate presentation unit 122 predicts a number of operations to be possibly executed on the electronic file. Based on the prediction results, the display state updating unit 125 updates the information to be displayed on the display screen 104. Due to the updating, an icon representing a newly predicted function is displayed on the display screen 104.

In step S5, when one functional icon is selected by clicking a mouse, or by a cursor on the key board 106, or by a touch panel, the selection detection unit 121 detects the function selected by the user.

In step S6, the instruction unit 126 issues instructions for executing the user-selected function from the functions represented by icons recognized by the selection detection unit 121, and thereby directs the execution of the operations.

In step S7, at the same time of step S6, the history updating unit 124 updates the operations history table B, in which operations executed previously are stored.

In steps S8a through S8d, lines in the electronic file information table C corresponding to the electronic file ID which lines are not stored in the first column of the operations history table B are deleted.

Below, an explanation is made of the case in which the electronic file icon selected in step S1 in FIG. 5 is an icon of a folder (below, referred to as “folder icon”).

When a folder icon is selected, step S1 is executed on all electronic files included in the folder corresponding to the selected folder icon. As a result, even when an icon of an electronic file is not selected by the user, it is possible to acquire the electronic file IDs of all the electronic files included in the folder corresponding to the selected folder icon in step S1.

When one icon of an electronic file included in the folder corresponding to the selected folder icon is selected by the user, because the electronic file ID of the electronic file corresponding to the selected electronic file icon has already been obtained in step S1, it is not necessary to acquire the electronic file ID from the electronic file information table C.

In addition, when one of the icons of the electronic files is selected by the user, because the electronic file IDs have been assigned to all electronic files in step S1, it is not necessary to refer to the electronic file information table C to confirm whether an electronic file ID has been assigned to the electric file corresponding to the selected icon.

In this way, by assigning electronic file IDs of electronic files in step S1 in advance, and/or, by acquiring the electronic file IDs of the electronic files in step S1 in advance, it is not necessary to access the electronic file information table C by selecting an icon of an electronic file, therefore, the prediction treatment can be performed at a high speed in the selection candidate presentation unit 122 described below.

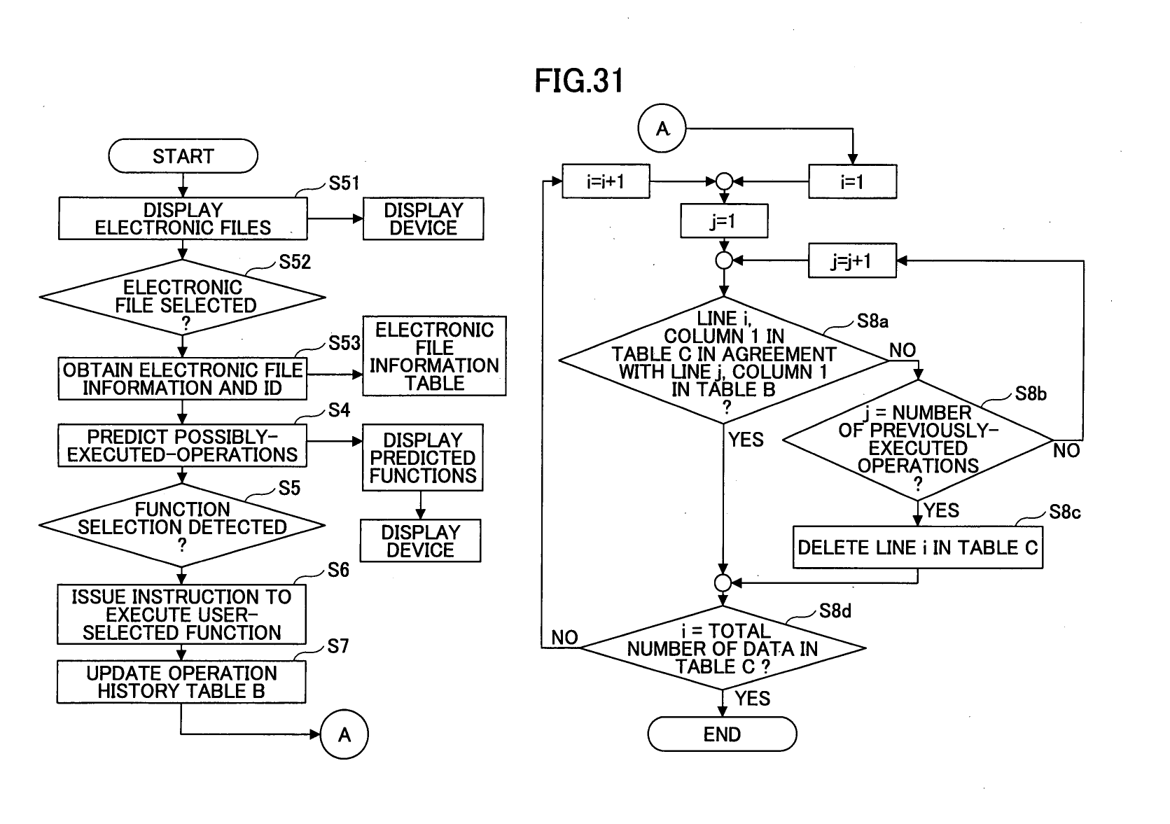

FIG. 31 is a flowchart illustrating operations of the information processing device 100 as another example of the process in steps S1 to S3 in FIG. 5.

In FIG. 31, steps other than steps S51 to S53 are the same as those in FIG. 5, and the same reference numbers are used. Below, only steps different from FIG. 5 are explained.

In step S51, the display state updating unit 125 displays the selected icon representing the electronic file (below, referred to as “electronic file icon”) on the display screen 104.

In step S52, when one electronic file icon is selected by clicking a mouse, or by a cursor on the key board 106, or by a touch panel, the selection detection unit 121 determines that an icon of an electronic file is selected.

In step S53, the electronic file information acquisition unit 123 determines whether information of the electronic file, which corresponds to the icon selected by the selection detection unit 121, exists in the electronic file information table C.

If the electronic file corresponding to the selected icon exists in the electronic file information table C, the corresponding electronic file ID is obtained.

If the electronic file corresponding to the selected icon does not exist, a new electronic file ID is assigned, and the newly assigned electronic file ID and information of the electronic file are written in the electronic file information table C.

Note that the newly assigned electronic file ID should be different from existing electronic file IDs.

In steps S51 to S53 in FIG. 31, when an electronic file icon is selected (step S52) from the electronic file icons displayed on the display screen 104 (step S51), only the electronic file ID of the electronic file corresponding to the selected electronic file icon is acquired. In this way, it is possible to only acquire the electronic file ID of the electronic file corresponding to the selected electronic file icon.

Therefore, different from the process in FIG. 5, the number of the electronic files, electronic file IDs of which ought to be acquired, is small, and the number of the electronic files, to which electronic file IDs ought to be assigned, is small. In this way, the electronic file IDs are assigned only to the selected electronic files, hence, it is possible to prevent unnecessary assignment of electronic file IDs to unselected electronic files, and it is possible to execute the prediction treatment at a high speed in the selection candidate presentation unit 122 described below.

As a modification to the process in FIG. 31, before one electronic file icon is selected by the user in step S52, the process in step S53 may be executed on all of the displayed electronic file icons. In this way, it is possible to acquire the electronic file IDs of all the displayed electronic files.

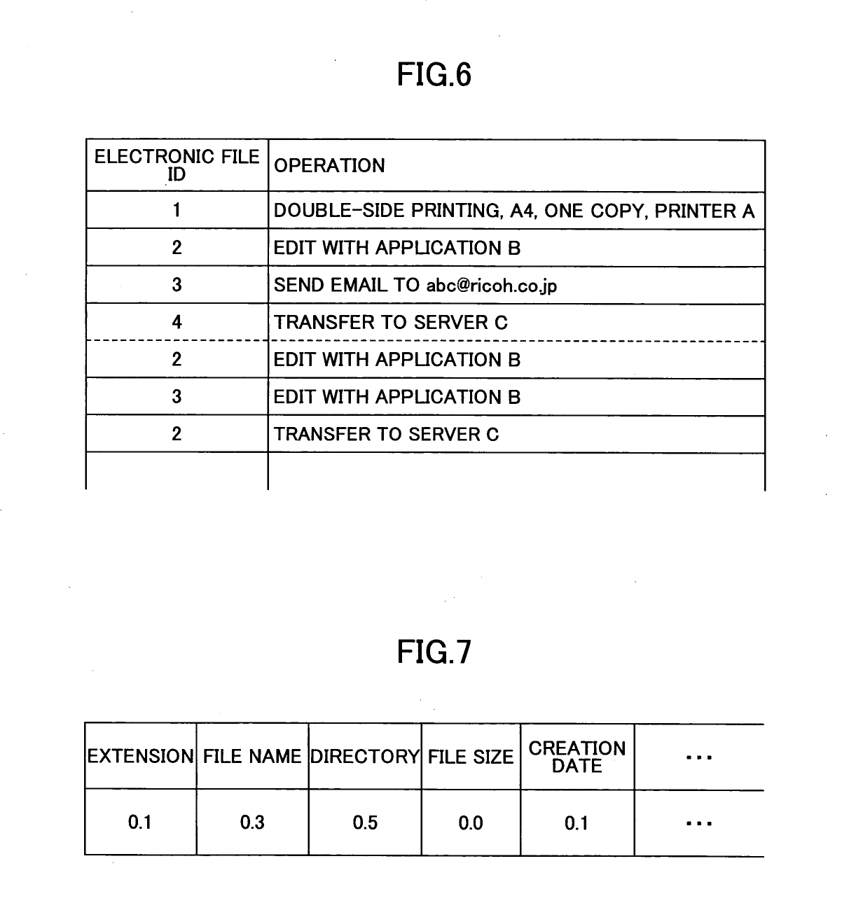

Further, if step S4 is repeatedly executed on all of the displayed electronic file icons, even before the user selects one electronic file icon, it is possible to predict multiple operations possibly to be performed on each of the displayed electronic file icons. In this way, prediction for all electronic file icons possibly selected by the user has been finished when one electronic file icon is selected. Due to this, the prediction is earlier than making prediction after one electronic file icon is selected, and this makes it possible to present selection candidates of functions predicted to be selected by the user. FIG. 6 illustrates an example of the operations history table B.

In the operations history table B, each time the execution of an operation is completed, one additional line is recorded in the table. In the first column of the operations history table B, electronic file IDs of the object electronic files are stored, on which operations in the operations history table B have been executed. In the second column of the operation history table B, the content of the operations executed on the object electronic files represented by the electronic file IDs in the first column are stored.

Here, it is shown that in the operations history table B shown in FIG. 6, only one line is assigned to one electronic file ID; however, plural lines can be assigned to one electronic file ID when plural operations have been executed on the corresponding electronic file.

Additionally, in the operations history table B, records of new operations are located at the bottom of the table; hence, when the storage capacity or processing capacity of the operations history table B is limited, the oldest operation history at the top of the table B can be deleted.

FIG. 7 illustrates an example of the parameter table A.

In the parameter table A, parameters constituting the electronic file information are stored. For example, in the first column of the parameter table A, there is stored a weight factor of the extension of an electronic file, the extension being used to represent a correspondence relation between electronic files.

In the second column of the parameter table A, there is stored a weight factor of the file name of the electronic file.

The correspondence relation between electronic files can be expressed by similarity of their extensions or similarity of file names of the electronic files, or by the size of the electronic files, or closeness of the directories where the electronic files exist. Below, a parameter is indicated by a suffix b, and a weight factor of the parameter b represented by “weight factor wb”.

The value of the weight factor wb may be a preset value, or may be changed along with execution of operations.

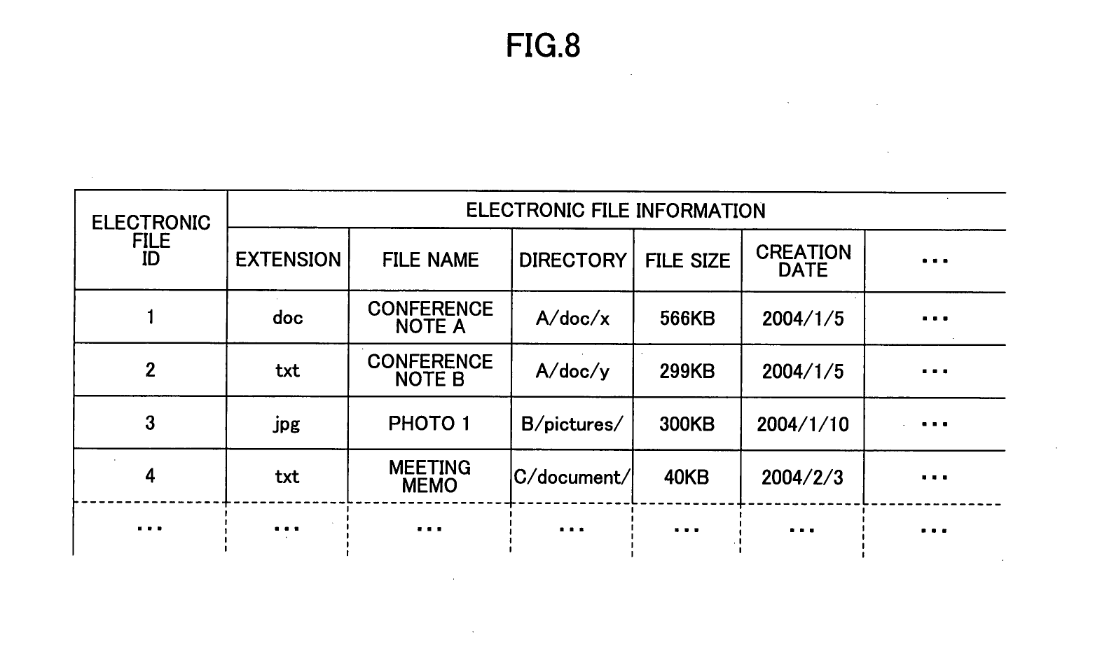

FIG. 8 illustrates an example of the electronic file information table C.

In the first column of the electronic file information table C, there are stored the electronic file IDs. In the second and subsequent columns, there is stored the electronic file information of electronic files.

The electronic file IDs in the first column of the electronic file information table C correspond to the electronic file IDs in the first column of the operations history table B in FIG. 6.

The electronic file information of electronic files may include the information in the parameter table A in FIG. 7 for expressing the correspondence relation between electronic files, such as extensions of the electronic files, file names of the electronic files, or sizes of the electronic files, closeness of the directories where the electronic files exist, and names of devices accommodating the electronic files.

Next, descriptions are made of the selection detection unit 121.

The selection detection unit 121 determines whether an icon on the display screen 104 is selected by a user in the following way. As shown in FIG. 2 and FIG. 3, when the coordinates of the arrow on the display screen 104 are in a range of the coordinates of the icon, and when the center button of the three buttons of the pointing device 107 is clicked, the selection detection unit 121 determines the icon on the display screen 104 that is selected. When the icon selected by the user is an electronic file icon, which is an icon representing an electronic file, the selection detection unit 121 identifies the electronic file ID of the electronic file. When the icon selected by the user is a functional icon, which is an icon representing a function, the selection detection unit 121 identifies the function.

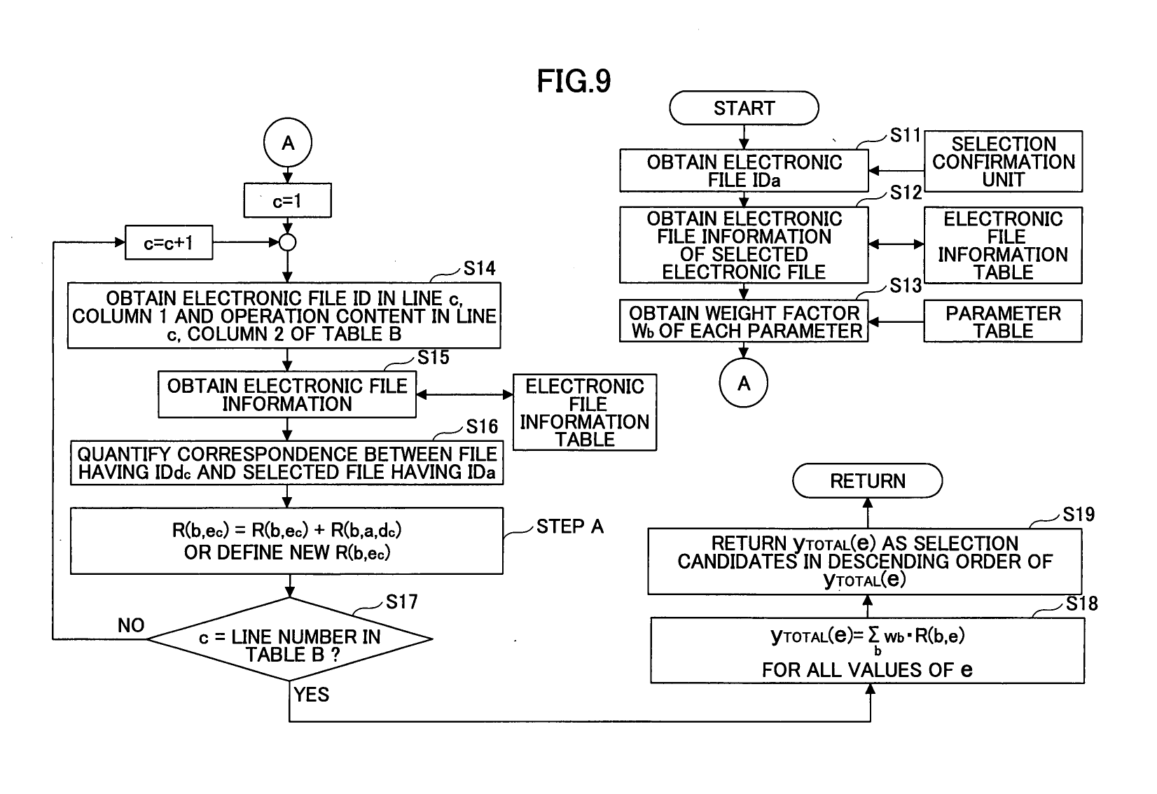

FIG. 9 is a flowchart illustrating an example of operations of the selection candidate presentation unit 122 in the information processing device 100.

In step S11, the selection candidate presentation unit 122 obtains the electronic file ID (referred to as “electronic file IDa”, below) of the electronic file identified by the selection detection unit 121.

In step S12, the selection candidate presentation unit 122 obtains the electronic file information corresponding to the electronic file IDa from the electronic file information table C.

In step S13, the selection candidate presentation unit 122 obtains the weight factor wb corresponding to parameters b of the electronic file information from the parameter table A. The previous operations stored in the lines of the operations history table B are processed from the first line of the operations history table B as shown in the following steps.

In step S14, the selection candidate presentation unit 122 obtains the electronic file ID which is stored in the first column of a c-th line of the operations history table B, and obtains operations content in the second column of the c-th line of the operations history table B. Below, this electronic file ID is denoted to be “electronic file IDd_{c}”, and this operations content is denoted to be “e_{c}”. In step S15, the selection candidate presentation unit 122 obtains the electronic file information corresponding to the electronic file IDd_{c} from the electronic file information table C.

In step S16, the selection candidate presentation unit 122 quantifies the correspondence relation between the electronic file corresponding to the electronic file IDd_{c} and the electronic file corresponding to the electronic file IDa reflected by the electronic file information of the two electronic files. For example, the selection candidate presentation unit 122 defines a quantity “R(b,a,d_{c})” to indicate the correspondence relation between the electronic file corresponding to the electronic file IDd_{c} and the electronic file corresponding to the electronic file IDa reflected by their electronic file information. Here, in the quantity R(b,a,d_{c}), the suffix “b” represents the parameters b, “a” represents the electronic file IDa, and “d_{c}” represents the electronic file IDd_{c}.

In detail, if the electronic file information is the extension given by an application (that is, a function) used by the electronic file, when the electronic file corresponding to the electronic file IDd, and the electronic file corresponding to the electronic file IDa have the same extension, the selection candidate presentation unit 122 assigns “1” to indicate the correspondence relation between the two electronic files, and when the two electronic file have different extensions, that is, the applications used by the two electronic files are different, the selection candidate presentation unit 122 assigns “0” to indicate the correspondence relation between the two electronic files. Alternatively, even when the two electronic file have different extensions, if the applications used by the two electronic files are related, the selection candidate presentation unit 122 may assigns a middle value. For example, when the extensions are “doc”, “ppt”, “xls”, characterized by applications for document edition, or presentation, or table calculation, that is, applications of the Microsoft Office Software system, the selection candidate presentation unit 122 may assign “0.5” to indicate the correspondence relation between the two electronic files.

If the electronic file information is the file names of the electronic files, the selection candidate presentation unit 122 uses a quantity related to the length of a character string included in both the file name of the electronic file corresponding to the electronic file IDd_{c} and the file name of the electronic file corresponding to the electronic file IDa to represent the correspondence relation between the two electronic files. For example, assume two file names “abcdefgh” (eight characters) and “abcdijkdefgh” (eleven characters); since character strings “abcd” (four characters) and “fgh” (three characters) are included in both of the file names, the quantity representing the correspondence relation between the two electronic files can be defined to be (4²×3²)/(8×11). In other words, the quantity representing the correspondence relation may be defined to be a ratio of a product of squares of the lengths of all identical character strings included in both of the two file names to a product of the lengths of the two file names.

If the electronic file information is the file size of the electronic files, the selection candidate presentation unit 122 uses a quantity related to a difference of the file size of the electronic files in units of kilobytes to represent the correspondence relation between the two electronic files.

For example, when the file size of one the electronic file is 30 KB, and the file size of one the electronic file is 40 KB, the quantity representing the correspondence relation between the two electronic files can be defined to be:
1/(40−30)=0.1

when the difference of the file size of the electronic files is zero, the quantity is defined to be 1.

If the electronic file information is the directory, for example, the selection candidate presentation unit 122 uses a quantity equaling one divided by a distance between two directories to represent the correspondence relation between the two electronic files. For example, the distance between two directories is defined to be the number of layers required to move between the two directories.

Specifically, assume the electronic file corresponding to the electronic file IDa is in a directory a/b/e/f, and the electronic file corresponding to the electronic file IDd_{c} is in a directory a/b/c/d; when moving from the directory a/b/e/f to the directory a/b/c/d, it is required to move in order of f→e→b→c→d, and in this case, the distance between the directory a/b/e/f and the directory a/b/c/d is defined to be 4.

If the electronic file information is the device names, or computer names, for example, when the electronic file corresponding to the electronic file IDd_{c} and the electronic file corresponding to the electronic file IDa have the same device name, the selection candidate presentation unit 122 assigns “1” to indicate the correspondence relation between the two electronic files, and when the two electronic file have different device names, the selection candidate presentation unit 122 assigns “0” to indicate the correspondence relation between the two electronic files. Of course, the selection candidate presentation unit 122 may assigns a middle value, such as “0.5” to indicate the correspondence relation between the two electronic files. For example, when computers belong to the same group, such as the same department of a company, a middle value, such as “0.5” is assigned to indicate the correspondence relation between the two electronic files. Additionally, if the devices are of the same type, for example, two computers, two work stations, or two printers able to store files, a middle value such as “0.5” is assigned to indicate the correspondence relation.

If the electronic file information is the date of creating the electronic file, for example, the selection candidate presentation unit 122 uses a quantity equaling one divided by a difference of the dates of creation between the two electronic files to represent the correspondence relation between the two electronic files. When the dates of creation of the two electronic files are the same, the quantity is defined to be 1.

For example, when the date of creating one electronic file is Jan., 1, 2002, and the date of creating the other electronic file is Jan., 11, 2002, the quantity representing the correspondence relation between the two electronic files is defined to be:
1/(11−1)=0.1.

Assume “R(b,e)” representing the correspondence relation between the two electronic files with respect to a certain operation, and “e” representing the operations content recorded in a certain line of the operations history table B, if R(b,e) has been defined at e=e_{c}, (that is, R(b,e_{c}) is known), the value of R(b,a,d_{c}) is added to R(b,e_{c}).

This process is indicated as “step A” in FIG. 9.

Steps S14 through S16 and the step A are repeated for each line in the operations history table B.

In step S18, a sum (wb*R(b,e)), denoted by a symbol “yₜₒₜₐₗ (e)”, is calculated with respect to all of the operations contents e and the electronic file information (parameters b).

In step S19, the operations contents e are determined to be selection candidates according to descending order of the values of yₜₒₜₐₗ (e). The number of selection candidates depends on the information processing device 100.

Below, examples of specific calculations are shown by using FIG. 6, FIG. 7, and FIG. 8. For example, consider a prediction operation for the electronic file having an electronic file ID equaling 1 in the electronic file information table C shown in FIG. 8.

First, an example of calculating the correspondence relation between the electronic file having an ID equaling 1 in the electronic file information table C and the electronic file having an ID=2 in the operations history table B shown in FIG. 6.

As shown in the operations history table B in FIG. 6, among the electronic files able to be accessed by the operations history table B following steps S11 through S15, the electronic file having an ID=2 is in the second data line, and the contents of operations executed on the electronic file having an ID=2 is shown to be “edit with application B”.

Hence, in this case, the electronic file IDa is 1, the electronic file IDd is 2 (thus, denoted to be “electronic file IDd₂”), the electronic file information (parameters b) includes “extension”, “file name”, “directory”, “file size”, and “creation date”, as shown in FIG. 8, and operations content e corresponding to the electronic file IDd₂ is “edit with application B”, which is denoted to be “e₂”.

First, according to step S16, from the electronic file information table C in FIG. 8, when the electronic file ID is 1, the extension is “doc”, and when the electronic file ID is 2, the extension is “txt”. Since the extensions are different, the correspondence R(extension, 1,2)=0. Here, the index “extension” indicates that the correspondence relation is evaluated with the electronic file information being “extension” (that is, the parameter b equals “extension”), and indexes 1,2 indicate that the electronic files under consideration have IDs of 1 and 2.

Next, consider the file name. From the electronic file information table C in FIG. 8, when the electronic file ID is 1, the file name is “conference note A”, and when the electronic file ID is 2, the file name is “conference note B”. Since the character string “conference note” is included in both file names, the correspondence R(filename, 1,2)=142/152=0.8711. Here, the index “extension” indicates that the correspondence relation is evaluated with the electronic file information being “filename” (that is, the parameter b equals “filename”).

Next, consider the directory. From the electronic file information table C in FIG. 8, when the electronic file ID is 1, the directory is “A/doc/x”, and when the electronic file ID is 2, the directory is “A/doc/y”, thus, the distance between the two directories is x→doc→y, the distance is 2, and the correspondence R(directory, 1,2)=½=0.5. Here, the index “directory” indicates the correspondence relation is evaluated with the electronic file information being “directory” (that is, the parameter b equals “directory”).

Next, consider the file size. From the electronic file information table C in FIG. 8, when the electronic file ID is 1, the file size is “566 KB”, and when the electronic file ID is 2, the file size is “299 KB”, their difference is 267 KB. thus, the correspondence R(file size, 1,2)= 1/267=0.00374. Here, the index “file size” indicates the correspondence relation is evaluated with the electronic file information being “file size” (that is, the parameter b equals “file size”).

Next, consider the creation date. From the electronic file information table C in FIG. 8, when the electronic file ID is 1, the creation date is “Jan. 5, 2000”, and when the electronic file ID is 2, the creation date is also “Jan. 5, 2000”, thus, the correspondence R(creation date, 1,2)=1. Here, the index “creation date” indicates the correspondence relation is evaluated with the electronic file information being “creation date” (that is, the parameter b equals “creation date”).

Similarly, the correspondence can be evaluated as follows.

R(extension, 1,1)=1,

R(filename, 1,1)=1,

R(directory, 1,1)=1,

R(file size, 1,1)=1,

R(creation date, 1,1)=1,

R(extension, 1,3)=0,

R(filename, 1,3)=0,

R(directory, 1,3)=0.25,

R(file size, 1,3)=0.00375,

R(creation date, 1,3)=0.2,

R(extension, 1,4)=0,

R(filename, 1,4)=0,

R(directory, 1,4)=0.25,

R(file size, 1,4)=0.00190,

R(creation date, 1,4)=0.0344.

In actual processes, the quantity R(b,a,d) is calculated sequentially by making reference to the operations history table B from the first line thereof, and each time, the quantity R(b,e_{c}) is calculated.

Because the operations history table B in FIG. 6 includes seven data lines, R(b,e_{c}) is calculated in order as below.

First, when c=1, as shown in the operation history table B in FIG. 6, e_{c}=“double-side printing, A4, one copy, printer A”. Since R(b, “double-side printing, A4, one copy, printer A”) is not defined yet, with respect to any electronic file information b, R(b, 1, 1) is newly defined as below.

R(extension, “double-side printing, A4, one copy, printer A”)=1,

R(filename, “double-side printing, A4, one copy, printer A”)=1,

R(directory, “double-side printing, A4, one copy, printer A”)=1,

R(file size, “double-side printing, A4, one copy, printer A”)=1,

R(creation date, “double-side printing, A4, one copy, printer A”)=1.

When c=2, as shown in the operations history table B in FIG. 6, e_{c}=“edit with application B”. Since R(b, “edit with application B”) is not defined yet, with respect to any electronic file information b, R(b, 1, 2) is newly defined as below.

R(extension, “edit with application B”)=0,

R(filename, “edit with application B”)=0.562,

R(directory, “edit with application B”)=0.5,

R(file size, “edit with application B”)=0.0034,

R(creation date, “edit with application B”)=1.

When c=3, as shown in the operations history table B in FIG. 6, e_{c}=“send email to abc@ricoh.co.jp”. Since R(b, “send email to abc@ricoh.co.jp”) is not defined yet with respect to any electronic file information b, R(b, 1, 3) is newly defined as below.

R(extension, “send email to abc@ricoh.co.jp”)=0,

R(filename, “send email to abc@ricoh.co.jp”)=0,

R(directory, “send email to abc@ricoh.co.jp”)=0.25,

R(file size, “send email to abc@ricoh.co.jp”)=0.00375,

R(creation date, “send email to abc@ricoh.co.jp”)=0.2.

When c=4, as shown in the operations history table B in FIG. 6, e_{c}=“transfer to server C”. Since R(b, “transfer to server C”) is not defined yet with respect to any electronic file information b, R(b, 1, 4) is newly defined as below.

R(extension, “transfer to server C”)=0,

R(filename, “transfer to server C”)=0,

R(directory, “transfer to server C”)=0.25,

R(file size, “transfer to server C”)=0.00190,

R(creation date, “transfer to server C”)=0.0344.

When c=5, as shown in the operations history table B in FIG. 6, e_{c}=“edit with application B”. Since R(b, “edit with application B”) is already defined at c=2 with respect to all electronic file information b, R(b, 1, 5) is further added, obtaining results as below.

R(extension, “edit with application B”)=0+0=0,

R(filename, “edit with application B”)=0.562+0.562=1.124,

R(directory, “edit with application B”)=0.5+0.5=1.0,

R(file size, “edit with application B”)=0.0034+0.0034=0.0068,

R(creation date, “edit with application B”)=1+1=2.

When c=6, as shown in the operations history table B in FIG. 6, e_{c}=“edit with application B”. Since R(b, “edit with application B”) is already defined at c=5 with respect to all electronic file information b, R(b, 1, 6) is further added, obtaining results as below.

R(extension, “edit with application B”)=0+0=0,

R(filename, “edit with application B”)=1.124+0=1.124,

R(directory, “edit with application B”)=1.0+0.25=1.25,

R(file size, “edit with application B”)=0.0068+0.00375=0.01055,

R(creation date, “edit with application B”)=2+0.2=2.2.

When c=7, as shown in the operations history table B in FIG. 6, e_{c}=“transfer to server C”. Since R(b, “transfer to server C”) is already defined at c=4 with respect to all electronic file information b, R(b, 1, 7) is further added, obtaining the following results.

R(extension, “transfer to server C”)=0+0=0,

R(filename, “transfer to server C”)=0+0.562=0.562,

R(directory, “transfer to server C”)=0.25+0.5=0.75,

R(file size, “transfer to server C”)=0.00190+0.0034=0.0053,

R(creation date, “transfer to server C”)=0.0344+1=1.0344.

Next, the sum (wb*R(b,e)) is calculated with respect to all of the operations contents e. According to the information in the parameter table A in FIG. 7, the weight factor wb obtained in step S13 has the following values, wₑₓₜₑₙₛᵢₒₙ=0.1, w_{filename}=0.3, W_{directory}=0.5, W_{file size}=0.0, W_{creation date}=0.1.

Thus, yₜₒₜₐₗ(“double-side printing, A4, one copy, printer A”)=0.1×1+0.3×1+0.5×1+0.0×1+0.1×1=1, similarly,

yₜₒₜₐₗ(“edit with application B”)=0.1×0+0.3×1.24+0.5×1+0.0×0.01055+0.1×2.2=1.1822,

yₜₒₜₐₗ(“send email to abc@ricoh.co.jp”)=0.1×0+0.3×0+0.5×0.25+0.0×0.00375+0.1×0.2=0.145,

yₜₒₜₐₗ(“transfer to server C”)=0.1×0+0.3×0.562+0.5×0.75+0.0×0.0053+0.1×1.0344=0.64704.

As described above, these calculations are performed in step S18.

Thus, as described in step S19, if the maximum number of functions to be present is two, in descending order of yₜₒₜₐₗ(e), “double-side printing, A4, one copy, printer A”, and “edit with application B” are presented.

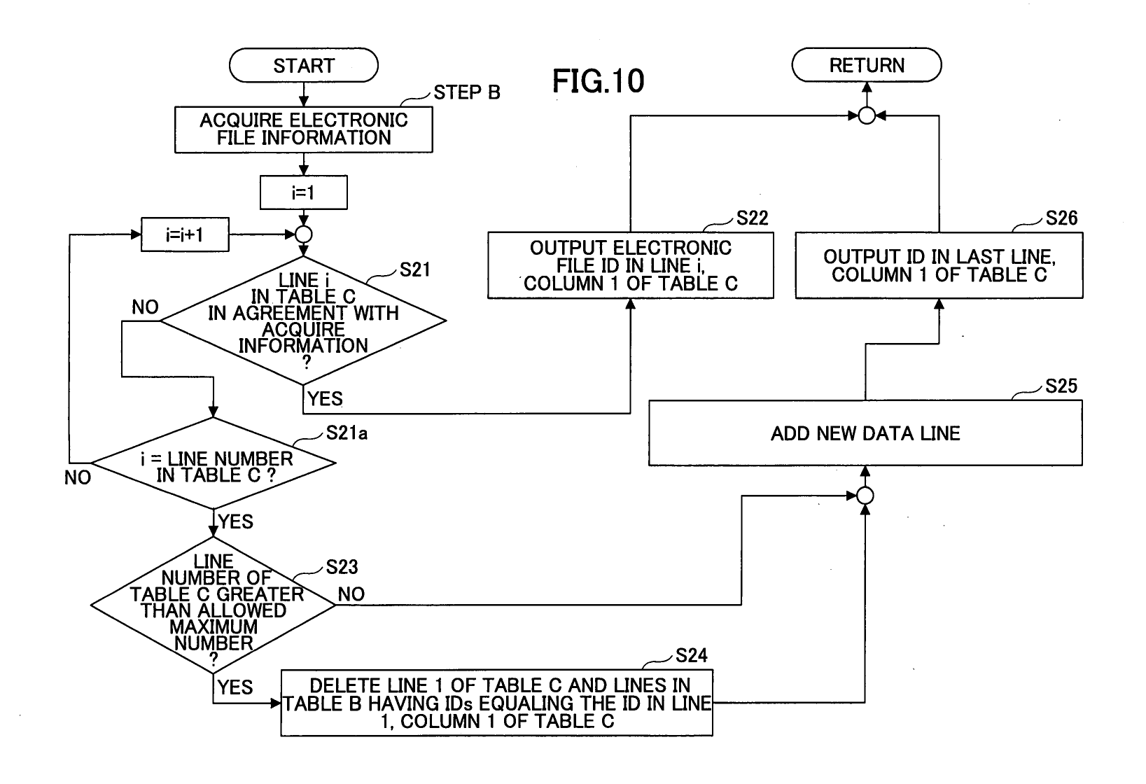

FIG. 10 is a flowchart illustrating an example of operations of the electronic file information acquisition unit 123 in the information processing device 100.

In step B shown in FIG. 10, the electronic file information acquisition unit 123 acquires one or more pieces of electronic file information of the electronic file to be processed.

In step S21, each of the pieces of acquired electronic file information is compared to the second and the subsequent columns in each line in the electronic file information table C as shown in FIG. 8.

When one of the pieces of acquired electronic file information is in agreement with one column in a certain line in the electronic file information table C, the electronic file information acquisition unit 123 proceeds to step S22.

When there is not any line in the electronic file information table C containing the electronic file information in agreement with the acquired electronic file information, the electronic file information acquisition unit 123 proceeds to step S21a.

In step S22, the electronic file information acquisition unit 123 outputs the electronic file ID in the first column of the line, and the routine is finished.

In step S21a, the electronic file information acquisition unit 123 determines whether the existing last line of the electronic file information table C has been reached.

If the last line of the electronic file information table C has been reached, the routine proceeds to step S23. Otherwise, the routine returns to step S21 to process the next line in the electronic file information table C.

In step S23, the electronic file information acquisition unit 123 determines whether the bottom (specified maximum number of lines) of the electronic file information table C has been reached, that is, whether the line index is greater than the specified maximum number of lines.

If the bottom of the electronic file information table C has been reached, the routine proceeds to step S24. Otherwise, the routine proceeds to step S25.

In step S24, the electronic file information acquisition unit 123 deletes the first data line of the electronic file information table C, and deletes the lines in the operations history table B having an electronic file ID the same as the electronic file ID stored in the first column of the first data line of the electronic file information table C.

In step S25, a new data line is added to last line position of the electronic file information table C, and a new electronic file ID, which is different from all other electronic file IDs in the electronic file information table C, is generated and stored in the first column of the newly added data line. In the second and subsequent columns of the new data line, the newly acquired pieces of electronic file information are stored.

In step S26, the electronic file information acquisition unit 123 outputs the electronic file ID generated in step S25.

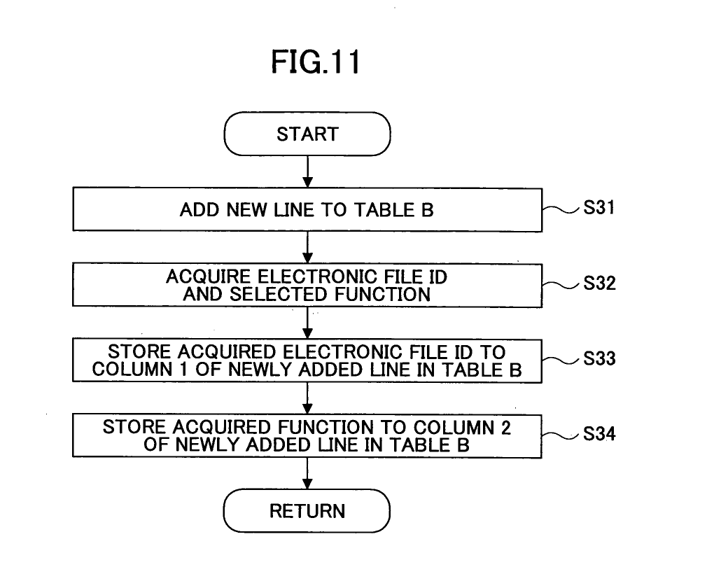

FIG. 11 is a flowchart illustrating an example of operations of the history updating unit 124 in the information processing device 100.

In step S31, the history updating unit 124 adds a new empty line at the end of the operations history table B.

In step S32, the history updating unit 124 acquires an electronic file ID and the selected function.

In step S33, the history updating unit 124 records the acquired electronic file ID to the first column of the newly added line of the operations history table B.

In step S34, the history updating unit 124 records the acquired function in the second column of the newly added line of the operation history table B.

Below, operations of the selection detection unit 121 are described.

When the selection detection unit 121 detects that the user has selected a function, the instruction unit 126 issues instructions to the device so as to execute the selected function on the electronic file selected by the user.

In the parameter table A of the present embodiment, the values stored in the table A may be set to be changeable depending on the trendency of the user after the user has executed an operation.

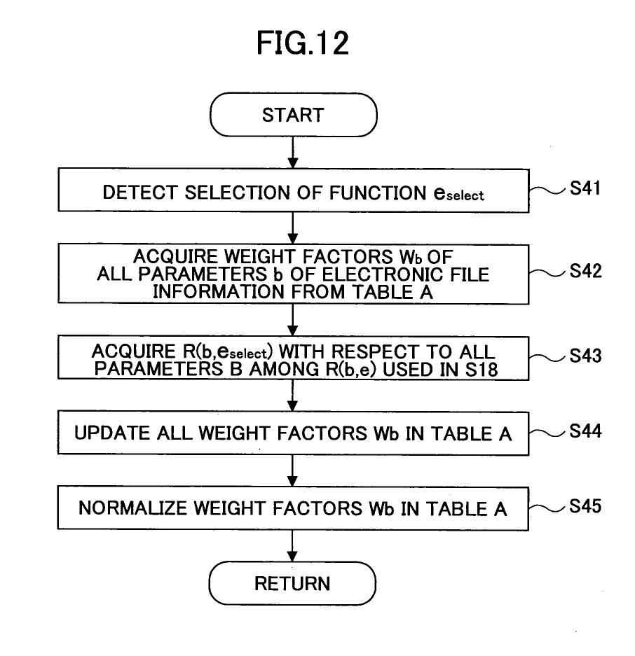

FIG. 12 is a flowchart illustrating an example of operations of the parameter updating unit 127 when the selection detection unit 121 detects that the user has selected a function e_{select}.

In step S41, the selection detection unit 121 detects that the user has selected a function e_{select}.

In step S42, the parameter updating unit 127 acquires the weight factors wb of all the parameters b constituting the electronic file information from the parameter table A.

In step S43, among R(b,e) used in step S18 by the selection candidate presentation unit 122, the parameter updating unit 127 acquires R(b,e_{select}) with respect to all the parameters b.

In step S44, with a specified parameter b, if R(b,e) becomes a maximum at e=e_{select}, the parameter updating unit 127 increases the value of the weight factor wb, which indicates magnitude of a contribution to the operations possibility of different electronic files. If R(b,e) does not become the maximum at e=e_{select}, the parameter updating unit 127 decreases the value of the weight factor wb. In this way, the parameter updating unit 127 updates values of all weight factors wb.

In step S45, the parameter updating unit 127 normalizes the weight factors wb so that the sum of all the weight factors wb becomes 1.

If the function e_{select} is not executed in step S18 by the selection candidate presentation unit 122, that is, the function e_{select} is not one of the functions used when calculating R(b,e), the weight factors wb are not updated.

As described above, according to the present embodiment, the information processing device 100 is able to determine the similarity between electronic files despite the formats of the electronic files, and is able to predict the next operation from the similarity. Therefore, it is possible to provide an information processing device of improved operability and able to efficiently predict operations to be conducted by a user when handling various kinds of electronic files.

Since the presentation of selection candidates to the user is based on the operational history and the electronic file information, when types of operations by the user are limited to a small number, since only operations intended by the user are presented, it is possible to come to the desired operations easily and more efficiently without any special setting.

Even when the types of operations by the user are of a large variety, because only operations frequently executed on similar electronic files are presented, it is possible to arrive at the desired operations easily and more efficiently without any special setting.

In addition, since selection functions are presented despite of types of the electronic files, history search of similar electronic files is performed even for electronic files which are not used yet.

In addition, according to the present embodiment, the information processing device 100 searches the operations history based on similarities of electronic files to perform prediction of operations on an electronic file. The similarities of electronic files are not obtained from specific formats of the electronic files, but from information generally possessed by the electronic files.

### Second Embodiment

The present embodiment discloses an information processing device which includes a configuration for printing in addition to the configuration of the information processing device of the first embodiment shown in FIG. 1 and FIG. 4, and thus can be used as a printer.

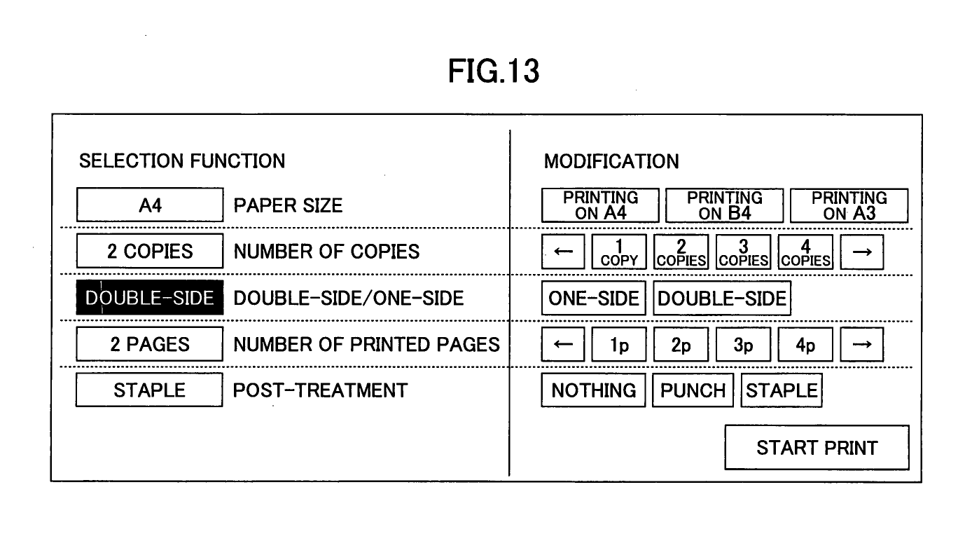

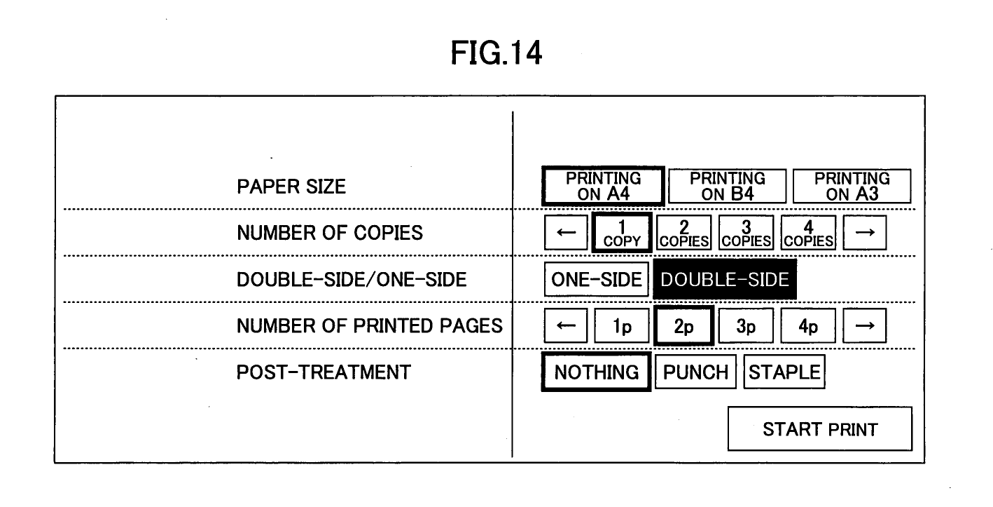

FIG. 13 and FIG. 14 show examples of settings displayed on a screen for forming an image by using a printer.

In the examples shown in FIG. 13 and FIG. 14, the selection functions predicted by the selection candidate presentation unit 122 are displayed on the screen.

In the operations history table B shown in FIG. 6, plural settings such as “printing”, “double-side”, “A4” are stored as one operation in one line, but each of plural settings in one line can be handled separately.

Settings concerning image formation may include-media for forming the image, such as plain paper, post cards, the size of the media, such as A4, B4, A3, the color of the image, such as white-black or full-color, and number of copies of the image media.

FIG. 13 is a block diagram showing an example in which functions in a selected state and selection candidates are displayed in different ways, and thus being distinguishable from each other. Specifically, in FIG. 13, the functions in the selected state are displayed as icons on the left side, and the selections for changing settings are displayed as buttons on the right side.

On the left side in FIG. 13, the functions predicted by the selection candidate presentation unit 122 are displayed as the initial state. When another function is selected by using a button on the right side in FIG. 13, the icons representing selected functions are changed. In this example, the functions predicted by the selection candidate presentation unit 122 and the function selected by the user are displayed in visually different manners such that they can be distinguished visually.

For example, the visually different manner may be realized by assigning different colors or sizes to the icons, or causing the icons to blink. In FIG. 13, “double-side” is highlighted as a function selected by the user.

FIG. 14 is a block diagram showing an example in which functions in a selected state and selection candidates are displayed in the same manner, thus not being distinguished from each other.

Specifically, in FIG. 14, all selection candidates are displayed as buttons, and the frames of the buttons of the selected functions are displayed to be thick.

As the initial state, the functions predicted by the selection candidate presentation unit 122 are displayed to have thick frames. When a function is selected by using a button of a selection candidate, the button frame of the selected function is displayed to be thicker than the usual frame thickness of the buttons. In this example, the functions predicted by the selection candidate presentation unit 122 and the function selected by the user are displayed in visually different manners such that they can be distinguished visually.

For example, the visually different manner may be realized by assigning different colors or sizes to the icons, or blinking of the icons. In FIG. 14, “double-side” is highlighted as a function selected by the user.

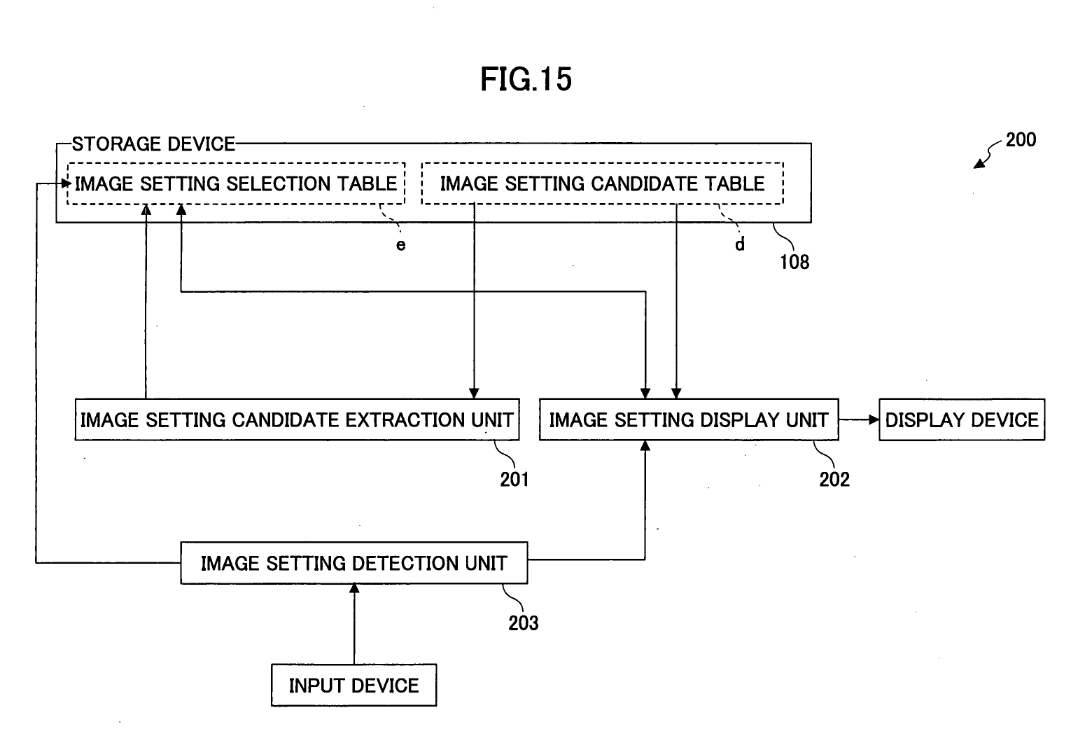

FIG. 15 is a block diagram illustrating an example of a configuration of an information processing device 200 of the present embodiment.

For example, the information processing device 200 includes an image setting candidate extraction unit 201 which extracts one setting predicted to be selected by the user for each type of the settings stored in an image setting candidate table D, an image setting display unit 202 which displays the setting candidates stored in the image setting candidate table D and the currently selected settings stored in an image setting selection table E on a display device, and an image setting detection unit 203 which, based on input data from an input device such as a pointing device like a mouse, searches the settings selected by the user, updates the settings stored in the image setting selection table E in accordance with the selected setting, and starts the image setting display unit 202 so that the settings on the display device are updated.

For example, these units can be implemented to be a module of a program to be executed by the CPU 101.

In the storage device 108, there are stored the image setting candidate table D which stores settings types used in image formation and selection candidates corresponding to the setting types, and the image setting selection table E which stores the settings currently selected by the user relative to the setting-types stored in the image setting candidate storage table D.

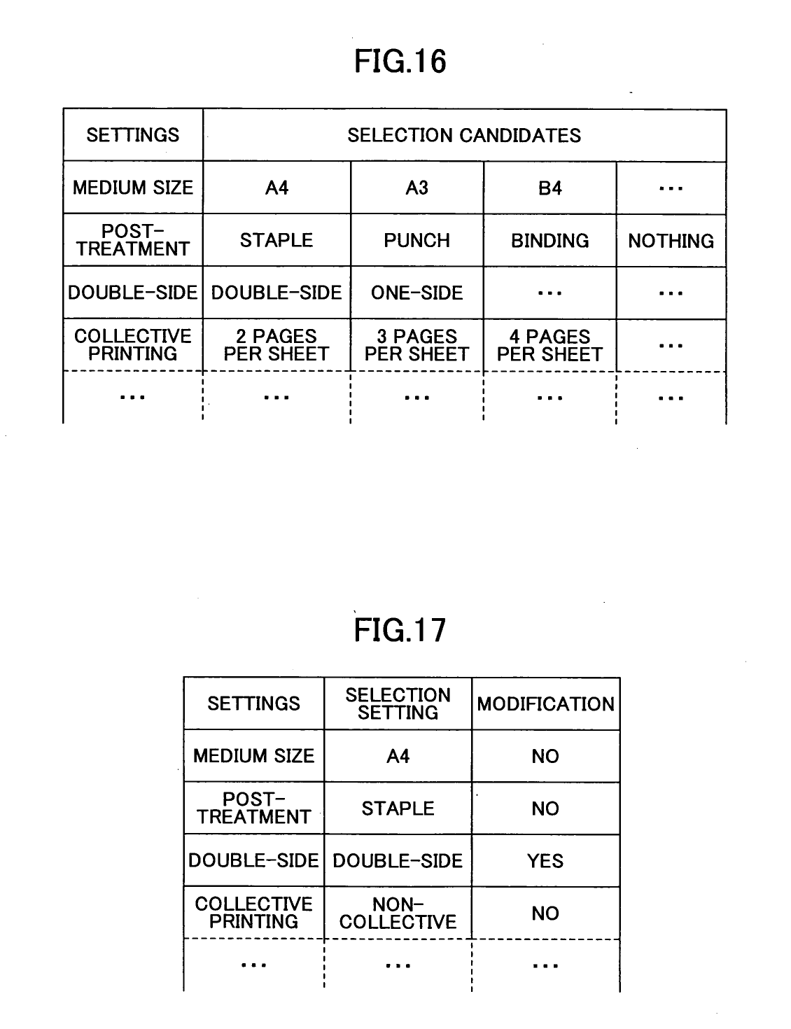

FIG. 16 is a table exemplifying the image setting candidate table D.

As shown in FIG. 16, types of settings are stored in the first column, and specific selection candidates corresponding to each setting type are stored in the second and the subsequent columns.

FIG. 17 is a table exemplifying the image setting selection table E.

As shown in FIG. 17, types of settings, which correspond to the types of settings in the image setting candidate table D, are stored in the first column, the settings currently selected by the user corresponding to each of the setting types are stored in the second column, and stored in the third column is information indicating whether the user has modified the current settings corresponding to each of the setting types.

Next, a description is made of an example of the image setting display unit 202.

The image setting display unit 202 makes reference to the image setting candidate table D, and displays all or part of the selection candidates of each setting type on the display device. For example, the selection candidates can be displayed as the buttons in the “modification” section on the right side in FIG. 13.

Further, the image setting display unit 202 makes reference to the image setting selection table E, and displays the selection settings stored in the second column of the table E on the display device. In this process, in the third column, lines recorded with “not modified” and “modified” are displayed such that they can be visually distinguished. For example, the selection settings can be displayed as the icons in the “selection function” section on the left side in FIG. 13. Alternatively, the selection settings can be displayed as the buttons having thick frames as shown in FIG. 14.

Next, a description is made of an example of the image setting detection unit 203.

When being started in correspondence to input data from an input device such as a pointing device like a mouse, the image setting detection unit 203 detects that the user has selected a certain selection candidate, searches for the selection candidate in the image setting candidate table D, and acquires the setting type in the first column of a line including a selection candidate the same as the selected candidate.

The image setting detection unit 203 searches for and obtains the acquired setting type in the image setting selection table E, outputs the selection setting in the second column having the setting type the same as the acquired setting type to the image setting display unit 202 as a selection candidate selected by the user, and updates the setting in the third column to be “modified”.

Next, a description is made of an example of the image setting candidate extraction unit 201.

When image formation is to be performed for an electronic file, the image setting candidate extraction unit 201 extracts the selection candidate which is presented as only one selection candidate in the selection candidate presentation unit 122 shown in FIG. 4.

When the object to be printed is not an electronic file, but a newly input text document, or a newly edited drawing, by using the electronic file information when saving the object to be printed as an electronic file, the image setting candidate extraction unit 201 extracts the selection candidate which is presented as only one selection candidate in the selection candidate presentation unit 122.

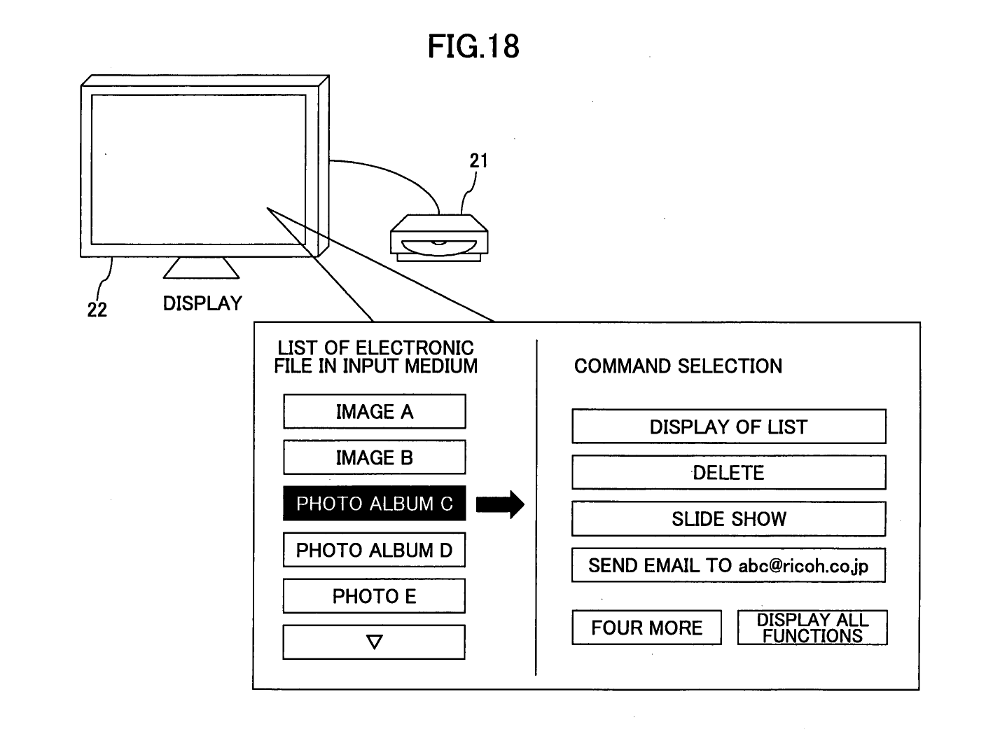

FIG. 18 is a block diagram illustrating another example of a configuration of the information processing device of the present embodiment, which reproduces data in a medium on the display.

As shown in FIG. 18, the device 21 of the information processing device of the present embodiment calls out the medium and displays the electronic files existing in the medium as electronic file icons. In the example shown in FIG. 18, icons representing images, or photo albums, or photos stored in the medium are displayed.

When of the icons is selected by using a hard button or a remote controller, the device 21 acquires information of the selected electronic file, and presents candidates of operations expected to be executed on the selected electronic file making reference to electronic files handled previously and the contents of the operations. In the example shown in FIG. 18, candidates such as “display of a list” of the contents in the photo album C, “deletion” of the contents in the photo album C, “slide show” display of the contents in the photo album C, and others are displayed. When the use select one of the operation candidates, the selected operation is executed on the selected electronic file.

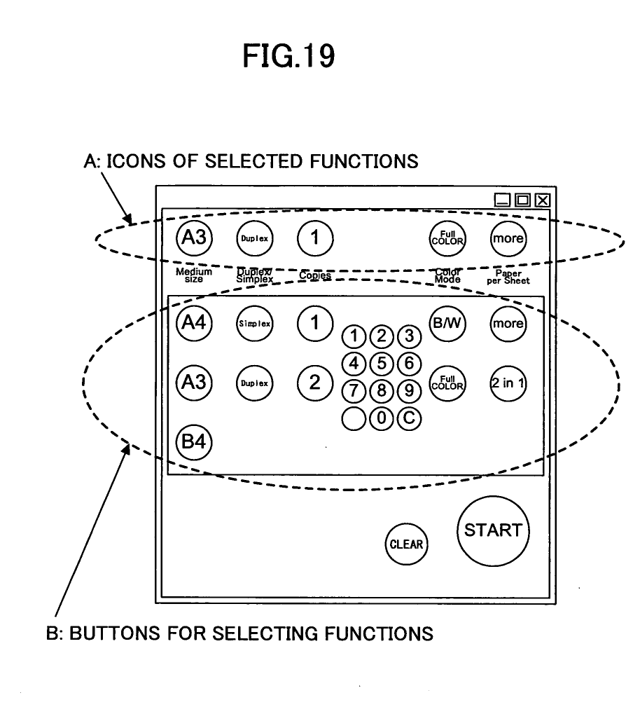

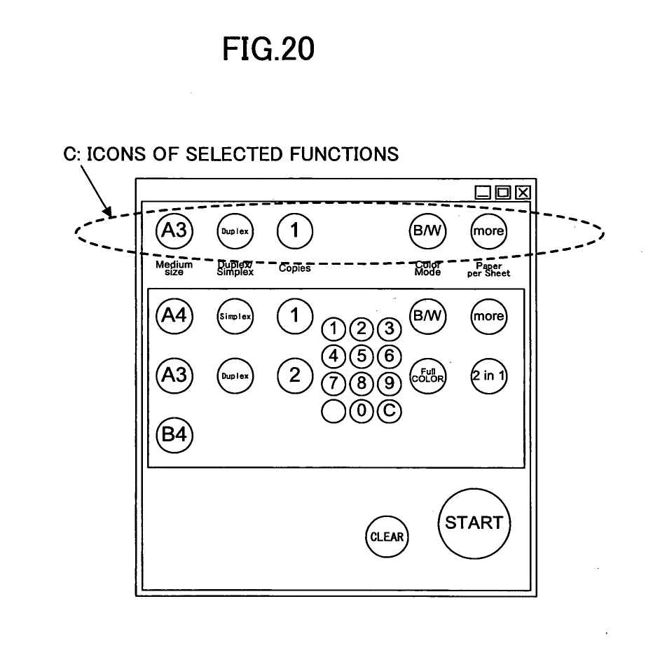

FIG. 19 and FIG. 20 illustrate another example of the information processing device of the present embodiment. Specifically, this example is related to display on a screen of printing settings when the user is to print an electronic file from a personal computer, namely, the present example is related to a printer driver.

FIG. 19 shows the initial state of the printer driver.

When an application is in execution, if the user issues an instruction to print, a window as shown in FIG. 19 is displayed on the screen.

In the portion A in FIG. 19, icons of the selected functions are displayed. Making reference to the information of the electronic file to be printed, the information of the electronic files previously printed and the selection status of the printing functions when printing the electronic files, the selection function for the current electronic file is predicted, and an icon of the predicted function is displayed in the portion A in FIG. 19 as a pre-selected function. If the pre-selected function is what the user desires, the user clicks a “START” button on the right-bottom corner with a mouse, and thereby printing is executed by utilizing the function in the selected state. The user may change function selection by clicking buttons in a portion B in FIG. 19 with a mouse.

FIG. 20 shows the state of the printer driver after the function selection is modified.

As shown in FIG. 20, relative to settings in FIG. 19, the size of the paper is changed from A4 to A3, and the color is changed from “full color” to “B/W”, that is, black-white.

In order for the user to easily distinguish between the functions newly selected by the user as a modification to the initial settings, and the predicted functions which are initially displayed on the screen, for example, the icon colors of the newly selected functions may be set to be different from the icon colors of the initial settings. Specifically, in a C portion in FIG. 20, the icon colors of “A3” and “B/W” are set to be different from the colors of other icons.

Similarly, when the user clicks the “START” button on the right-bottom corner with a mouse, printing is executed by utilizing the function in the selected state.

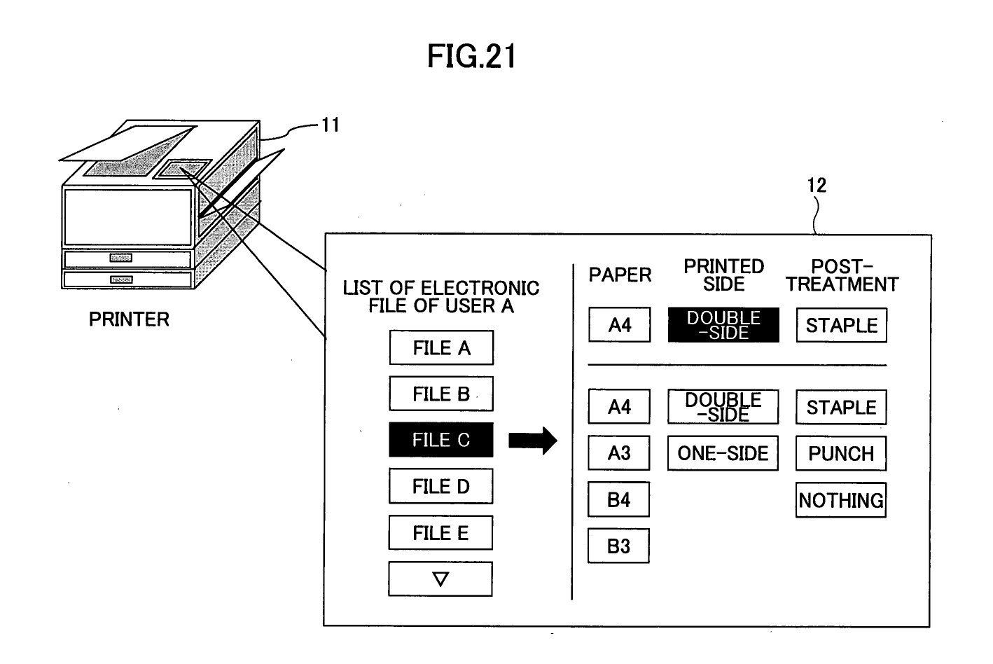

FIG. 21 illustrates another example of the information processing device of the present embodiment. Specifically, this example is related to a printer 11 which includes a storage unit; documents can be stored in the printer 11, and the printer 11 can call out these documents for printing.

When a document stored in the printer 11 is invoked, a list of electronic file icons representing documents is shown on a display 12 having a touch panel. When one of the electronic file icons is selected by the touch panel, from the information of the selected document, the operations history is referred to, and thereby, function candidates to be executed on the selected document are presented. Here, among the function candidates, the function most likely to be selected is placed at the top of the list. If the user further touches the touch panel to change the function, as shown in FIG. 15, the newly selected function is highlighted. The user presses a hard button on the printer 11, and the selected function is executed on the selected electronic file.

As described above, according to the information processing device of the present embodiment, when forming an image by a printer, concerning one or more settings, one predicted function is displayed as a pre-selected function for each of the settings; due to this, when the predicted function is what the user desires, the predicted function can be executed without additional selection operations. In addition, because a selection candidate is displayed at the same time as an alternative of the predicted function, even when the predicted function is not what the user desires, it is still very easy to reach the desired function. In addition, because the functions which are predicted in advance and are in a selected state, and the functions which are selected by the user and turning to the selected state are visually distinguished on the screen, the user can easily determine which function is selected by himself.

In addition, according to the information processing device of the present embodiment, during image formation, when presenting the function selection candidates, the function considered to be the most probable selection is presented in a pre-selected state. In the case when the predicted function is selected and executed directly, and in the case when this function is modified by the user and selected, these function are displayed so as to be visually distinguished.

The present invention is applicable to a device for multiple users. In this case, the present invention can be implemented at least in the following two ways. First, when the ways of using the device by different users are not so different, the previously-handled electronic files, the operations history, and parameters can be shared by all the users. Namely, one parameter table A, one operations history table B, and one electronic file information table C are provided, and all users commonly use these tables. Second, when the ways of using the device by different users are quite different, the previously-handled electronic files, the operations history, and parameters are stored separately for each of the users, Namely, there are provided a number of sets of the parameter tables A, the operations history tables B, and the electronic file information tables C, greater than the number of user IDs, and different users use different sets of the tables. In this case, the device of the present invention needs a configuration for identifying user IDs.

When settings and operations history are stored separately for different users, it is possible to determine similarities of electronic files and utilize operational tendencies specific to each user. On the other hand, when settings and operations history are commonly shared by all users, it is possible to find which user uses which functions.

Printing history information of the information processing device of the present invention was collected, which includes a total of 77719 printing history records of 77 users, and nine attributes of the collected printing history information were analyzed. The printing history information included the setting of double-side printing or one-side printing, the setting of collective printing or non-collective printing, the setting of color printing or black-white printing, the setting of the number of pages of the manuscript to be printed, the setting of the number of copies to be printed, the setting of the number of pages to be printed, the setting of the medium size, the setting of the extension of the printed files, and the setting of the date of printing.

The analysis of the collected printing history information is outlined below.

First, correlation coefficients of nine attributes among the printing history information were calculated.

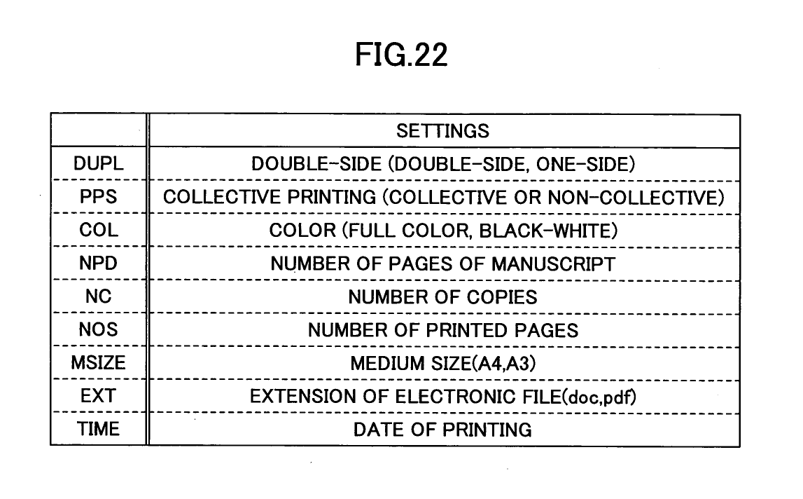

FIG. 22 is a table showing symbols of the nine attributes.

As shown in FIG. 22, the attribute indicating the setting of double-side printing or one-side printing is denoted by a symbol “DUPL”, the attribute of the setting of collective printing or non-collective printing is denoted by a symbol “PPS”, the attribute of the setting of color printing or black-white printing is denoted by a symbol “COL”, the attribute of the setting of the number of pages of the manuscript to be printed is denoted by a symbol “NPD”, the attribute of the setting of the number of copies to be printed is denoted by a symbol “NC”, the attribute of the setting of the number of printed pages is denoted by a symbol “NOS”, the attribute of the setting of the medium size is denoted by a symbol “MSIZE”, the attribute of the setting of the extension of the file to be printed is denoted by a symbol “EXT”, and the attribute of the setting of the date of printing is denoted by a symbol “TIME”.

In the present analysis, the correlation coefficient is defined to be a so-called “Cramer's value”, which equals zero when there is no correlation at all, and equals one when there is complete correlation. For example, when the double-side printing is always performed along with the collective printing, and the one-side printing is always not performed along with the collective printing, the correlation coefficient equals one. Meanwhile, the correlation coefficient equals zero in a state very close to the state in which the collective printing is always performed despite double-side printing or one-side printing. Here, “very close to the state” means “very close without limits”, because in the state in which the collective printing is always performed despite double-side printing or one-side printing, the calculation of the Cramer's values involves division by zero, and cannot be calculated.

Below, descriptions are made of the calculations of the Cramer's values as shown in A), B), and C).

It should be noted that in all the analyses, correlations between the double-side printing and the number of printed page, the collective printing and the number of printed page, the number of pages of the manuscript and the number of printed page, the number of copies to be printed and the number of printed pages, are not considered. For example, with a setting of the double-side printing, the number of printed pages will definitely be reduced, namely, even when correlation exists between these two quantities, the correlation relation is simple and obvious. Further, correlation between the number of pages of the manuscript and the extension and the date of printing is not considered in the analyses.

A). For all of the 77719 sets of data, nine attributes and the Cramer's values between the attributes are calculated to analyze the overall trendency.

B). The 77719 sets of data are divided into history data of 77 users, and the same calculation as A) is made for each user to analyze correlations specific to part of the users.

C). Data of each user obtained in B) are further analyzed month by month by making the same calculation as A) for each user in each month. This calculation discloses correlations specific to part of the users in some months. Based on this calculation, it is helpful to cope with a change with time of the trendency of a user's operation.

Detailed analysis results are presented below.

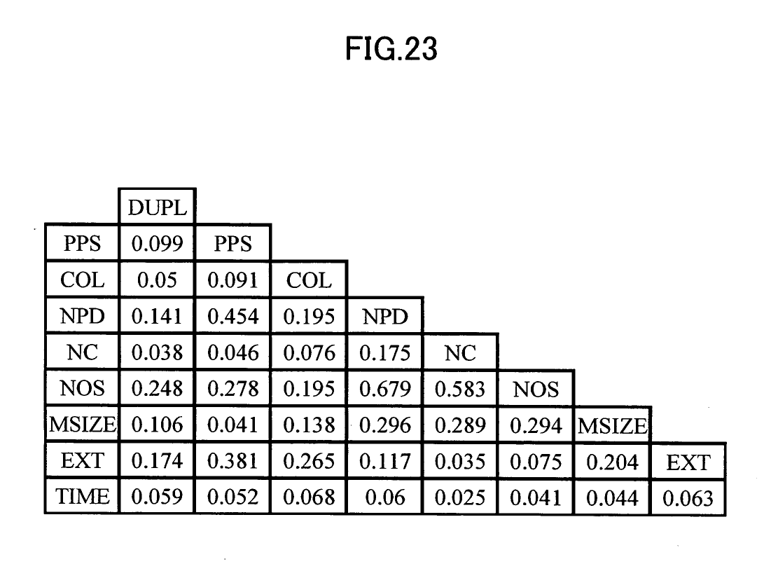

1). Results of all of the 77719 sets of data FIG. 23 is a diagram showing the Cramer's values representing the correlations between every two of the nine attributes as shown in FIG. 22.

As shown in FIG. 23, the attribute of the collective printing (PPS) and the attribute of the number of pages of the manuscript (NPD) have a strong correlation compared to other attributes; similarly, the attribute of the collective printing (PPS) and the attribute of the extension (EXT) have a strong correlation compared to other attributes.

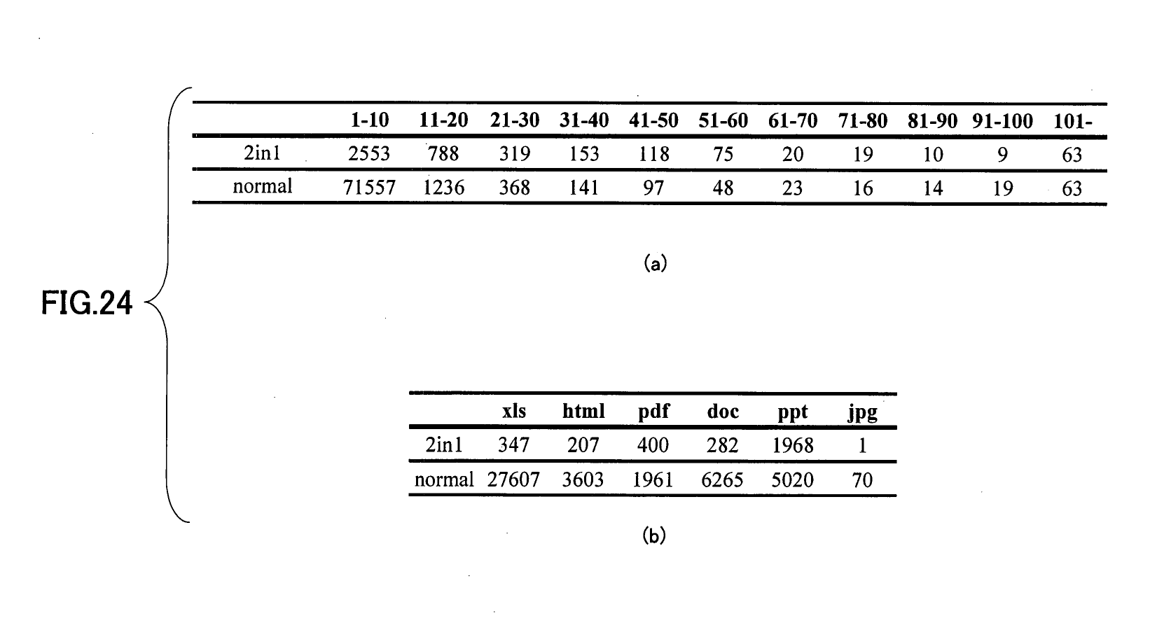

FIG. 24A is a table showing the correlation between the attribute of the collective printing (PPS) and the attribute of the number of pages of the manuscript (NPD).

In FIG. 24A, data in the table are the number of times of printing operations actually executed.

As shown in FIG. 24A, when the number of pages of the manuscript increases (1-10 pages, 11-20 pages, 21-30 pages, 31-40 pages, 41-50 pages, 51-60 pages, 61-70 pages, 71-80 pages, 81-90 pages, 91-100 pages, and more than 101 pages), it was found that the percentage of the collective printing (represented by “2in1”) increases, namely, the number of times of collective printing increases relative to normal printing without collectiveness (represented by “normal”).

FIG. 24B is a table showing the correlation between the attribute of the collective printing (PPS) and the attribute of the extension (EXT).

In FIG. 24B, data in the table are the number of times of printing operations actually executed.

As shown in FIG. 24B, for all kinds of extensions (xls, html, pdf, doc, ppt, and jpg), it was found that the percentage of the non-collective printing (normal printing without collectiveness, represented by “normal”) is high, and existence of correlation was not confirmed.

2). Dividing the 77719 sets of data into 77 divisions of history data of 77 users It is desirable that the same calculation as that in 1) be made for each of the 77 users, but it is not realistic. Instead, the Cramer's values between every two of the nine attributes in FIG. 22 for each of the 77 users were calculated, and distributions of the Cramer's values were investigated, and the Cramer's values at 10% from the top in the corresponding distributions are extracted for analysis.

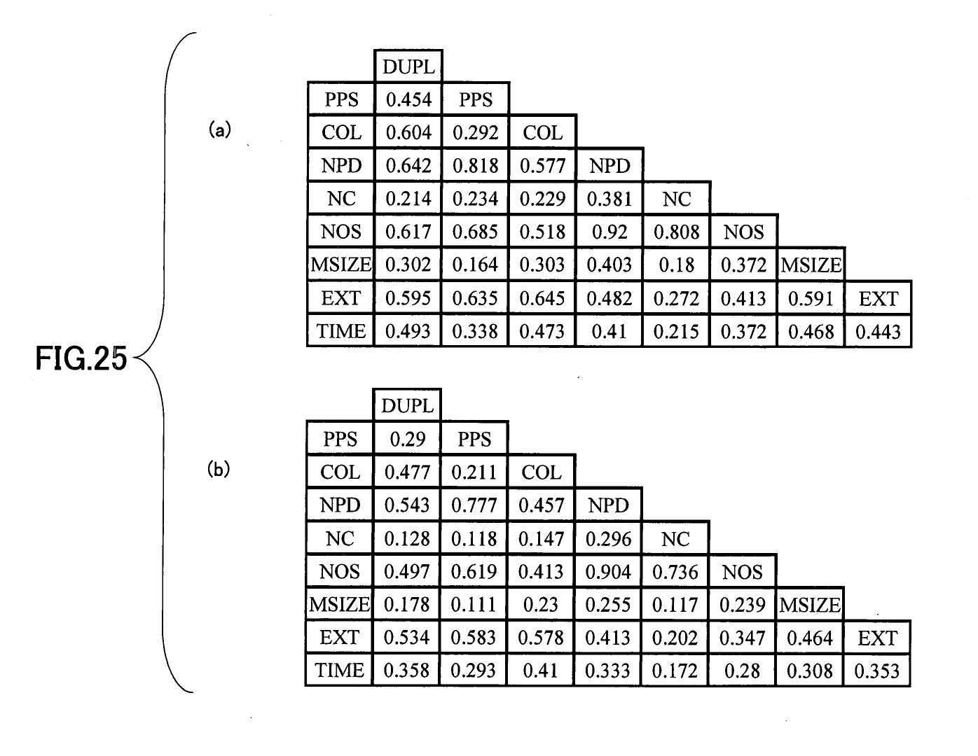

FIG. 25A is a diagram showing the Cramer's values at 10% from the top in the corresponding distributions of the Cramer's values for different users.

Specifically, in the table in FIG. 25A, the Cramer's value “0.454” at the top of the first column is obtained in the following way. The Cramer's values between the attribute of collective printing (PPS) and the attribute of double-side printing (DUPL) are calculated for each of the 77 users, and among thus obtained 77 Cramer's values, the Cramer's value at 10% from the top, namely, 77×0.1=7.7, that it, the eighth Cramer's value from the top is extracted which equals 0.545.

As shown in the table In FIG. 25A, correlations between the following attributes are relatively strong compared to other attributes, that is, the attribute of double-side printing (DUPL) and the attribute of color printing (COL), the attribute of collective printing (PPS) and the attribute of the number of pages of the manuscript (NPD), the attribute of double-side printing (DUPL) and-the attribute of the number of pages of the manuscript (NPD), the attribute of color printing (COL) and the attribute of the number of pages of the manuscript (NPD), the attribute of color printing (COL) and the attribute of the number of printed pages (NOS), the attribute of double-side printing (DUPL) and the attribute of the extension (EXT), the attribute of collective printing (PPS) and the attribute of the extension (EXT), the attribute of color printing (COL) and the attribute of the extension (EXT), the attribute of the number of pages of the manuscript (NPD) the attribute of the extension (EXT), the attribute of the medium size (MS) and the attribute of the extension (EXT), and the attribute of color printing (COL) and the attribute of the date of printing (TIME).

Correlations of these attributes probably exist for part of the users.

FIG. 25B is a diagram showing the Cramer's values at 20% from the top in the corresponding distributions of the Cramer's values for different users.

Specifically, in the table in FIG. 25B, the Cramer's value “0.29” at the top of the first column is obtained in the following way. The Cramer's values between the attribute of collective printing (PPS) and the attribute of double-side printing (DUPL) are calculated for each of the 77 users, and among thus obtained 77 Cramer's values, the Cramer's value at 20% from the top, namely, 77×0.2=15.4, that it, the 16th Cramer's value from the top is extracted which equals 0.29.

As shown in the table in FIG. 25B, similar to the results shown in the table In FIG. 25A, correlations between the above attributes (that is, DUPL and COL, PPS and NPD, DUPL and NPD, COL and NPD, COL and NOS, DUPL and EXT, PPS and EXT, COL and EXT, NPD and EXT, MS and EXT, and COL and TIME) are relatively strong compared to other attributes, and correlations of these attributes probably exist for part of the users.

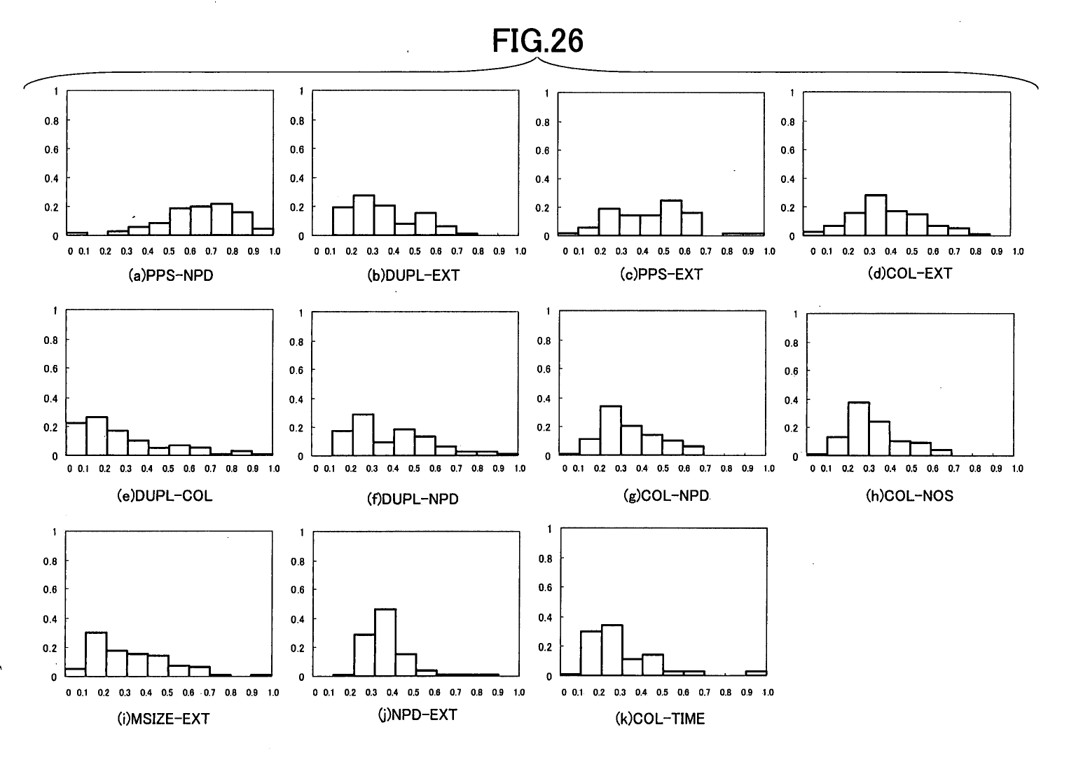

FIG. 26A through 26K are histograms illustrate distributions of the Cramer's values of the above 11 pairs of attributes to confirm existence of correlations between them.

FIG. 26A shows the relation between the attribute of collective printing (PPS) and the attribute of the number of pages of the manuscript (NPD). In the distribution in FIG. 26A, there is a peak at the right side, and this reveals that the correlation relation between the attribute of collective printing (PPS) and the attribute of the number of pages of the manuscript (NPD) exists for many users.

FIG. 26B shows the relation between the attribute of double-side printing (DUPL) and the attribute of the extension (EXT).

FIG. 26C shows the relation between the attribute of collective printing (PPS) and the attribute of the extension (EXT).

FIG. 26F shows the relation between the attribute of double-side printing (DUPL) and the attribute of the number of pages of the manuscript (NPD).

In each of the distributions in FIG. 26B, FIG. 26C, and FIG. 26F, there are two peaks, one is at the left side, and the other one is at relatively right side. Such distributions reveal that the correlation relations between DUPL and EXT, PPS and EXT, DUPL and NPD exist for some users but not for other users.

FIG. 26D shows the relation between the attribute of color printing (COL) and the attribute of the extension (EXT).

In the distribution in FIG. 26D, although there are not two peaks, but the abscissa around 0.5-0.6 is right, and this reveals that the correlation relation between COL and EXT exists for some users.

Meanwhile, in each of the distributions in FIG. 26E, which shows the relation between the attribute of double-side printing (DUPL) and the attribute of color printing (COL), FIG. 26G, which shows the relation between the attribute of double-side printing (DUPL) and the attribute of the number of pages of the manuscript (NPD), FIG. 26H, which shows the relation between the attribute of color printing (COL) and the attribute of the number of pages of the manuscript (NPD), FIG. 26I, which shows the relation between the attribute of the medium size (MSIZE) and the attribute of the extension (EXT), FIG. 26J, which shows the relation between the attribute of the number of pages of the manuscript (NPD) and the attribute of the extension (EXT), and FIG. 26K, which shows the relation between the attribute of color printing (COL) and the attribute of the date of printing (TIME), there is one peak at the left side, revealing that a correlation relation between the above attributes does not exist.

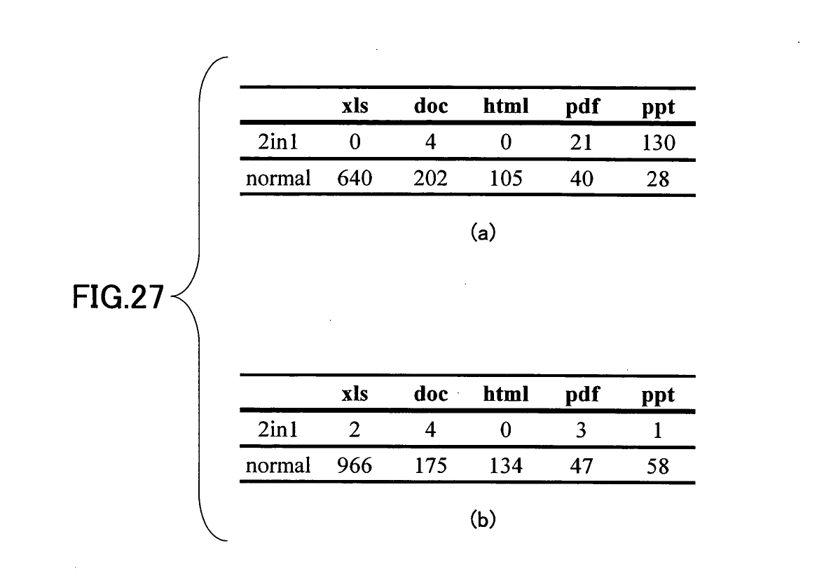

FIG. 27A and FIG. 27B are tables showing the examples of correlations between the attribute of the collective printing (PPS) and the attribute of the extension (EXT) for specific users.

In FIG. 27A and FIG. 27B, data in the tables are the number of times of printing operations actually executed.

As shown in FIG. 27A, depending on the attribute of the extension (EXT), the attribute of the collective printing (PPS) changes (collective or non-collective), in other words, regarding the user shown in FIG. 27A, correlation exists between the collective printing (PPS) and the extension (EXT).

Meanwhile, as shown in FIG. 27B, despite the attribute of the extension (EXT), the attribute of the collective printing (PPS) does not change, and normal printing is always executed. In other words, for the user shown in FIG. 27B, correlation does not exist between the collective printing (PPS) and the extension (EXT).

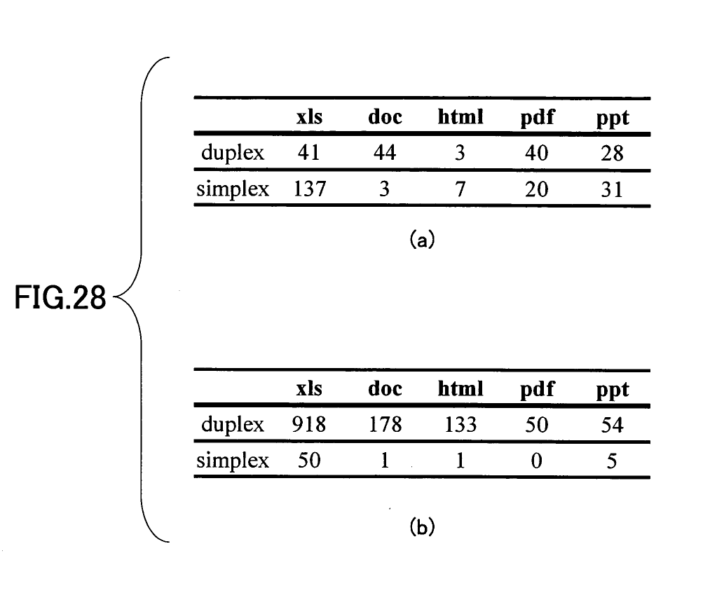

FIG. 28A and FIG. 28B are tables showing examples of correlations between the attribute of double-side printing (DUPL) and the attribute of the extension (EXT) for specific users.

In FIG. 28A and FIG. 28B, data in the tables are the number of times of printing operations actually executed.

As shown in FIG. 28A, depending on the attribute of the extension (EXT), the attribute of the double-side printing (DUPL) changes (double-side (denoted by “duplex”) or one-side printing (denoted by “simplex”)), in other words, regarding the user shown in FIG. 28A, correlation exists between the attribute of the double-side printing (DUPL) and the attribute of the extension (EXT).

As shown in FIG. 28B, for all kinds of extensions (EXT), the attribute of the double-side printing (DUPL) is fixed to double-side printing. In other words, regarding the user shown in FIG. 28B, correlation does not exist between the attribute of the double-side printing (DUPL) and the attribute of the extension (EXT).

3). Data of each user were further analyzed month by month in the same way as in 2). From the analysis results, it is found that in some months, correlation exists between the attribute of color printing (COL) and the attribute of the number of pages of the manuscript (NPD), and between the attribute of the medium size (MS) and the attribute of the extension (EXT).

First, consider the relation between the attribute of color printing (COL) and the attribute of the number of pages of the manuscript (NPD), which is similar to that shown in FIG. 26G. In the distribution of the correlation between COL and NPD, there are two peaks in four months among six months, and one peak is on the right side of 0.5. This distribution reveals that the correlation relation between COL and NPD exists for some users.

Next, consider the relation between the attribute of the medium size (MS) and the attribute of the extension (EXT), which is similar to that shown in FIG. 26I. In the distribution-of the correlation between MS and EXT, there is one peak on the right side of 0.5 in four months among six months. This distribution reveals that the correlation relation between MS and EXT exists for some users.

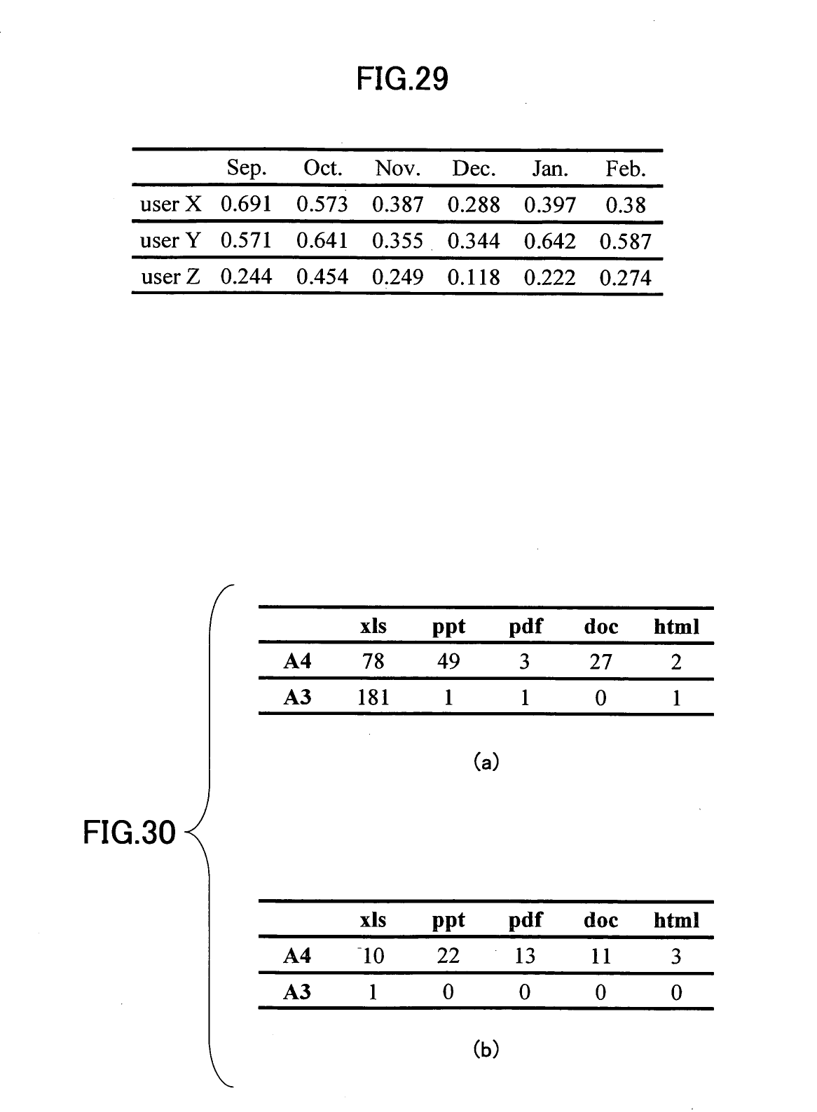

FIG. 29 is a table showing examples of changes of the Cramer's value between the attribute of the medium size (MS) and the attribute of the extension (EXT) along with months for three users X, Y, and Z.

As shown in FIG. 29, for the user X, the Cramer's value is 0.691 in September, showing a relatively strong correlation; meanwhile, the Cramer's value is 0.288 in December, showing a relatively weak correlation.

FIG. 30A and FIG. 30B are tables showing specific data of the user X in September and December, respectively.

In FIG. 30A and FIG. 30B, data in the tables are the number of times of printing operations actually executed.

As shown in FIG. 30A and FIG. 30B, the user X was inclined to use A3 size paper only for xls files in September, but was inclined to use A4 size paper for all kinds of files in December.

Summarizing the above analysis results, first, as an overall trend, the correlation between the attribute of collective printing (PPS) and the attribute of the number of pages of the manuscript (NPD) is strong, that is, the number of pages of the manuscript (NPD) increases, the collective printing (PPS) is frequently used.

Second, from FIG. 26B, FIG. 26C, FIG. 26D, FIG. 26F, for some users, the correlation exists between the attribute of double-side printing (DUPL) and the attribute of the extension (EXT), the attribute of collective printing (PPS) and the attribute of the extension (EXT), the attribute of color printing (COL) and the attribute of the extension (EXT), and the attribute of double-side printing (DUPL) and the attribute of the number of pages of the manuscript (NPD).

Third, for some users in some months, correlation exists between the attribute of color printing (COL) and the attribute of the number of pages of the manuscript (NPD), and between the attribute of the medium size (MS) and the attribute of the extension (EXT).

From the above analysis, it is revealed that the extension (EXT) of an electronic file imposes lot of influences on printing settings. The examples shown in FIG. 19 and FIG. 20 make use of this phenomenon to predict the printing settings from the operations history records based on the extensions of electronic files.

While the present invention is described above with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Applications No. 2004-357163 filed on Dec. 9, 2004, and No. 2005-303317 filed on Oct. 18, 2005, the entire contents of which are hereby incorporated by reference.

What is claimed is:

1. An information processing device, comprising:
an electronic file information acquisition unit configured to acquire information of an electronic file;
a history information acquisition unit configured to acquire operations history information including information of operations previously performed on the electronic file;
a weight factor acquisition unit configured to acquire weight factors assigned to a plurality of parameters of the electronic file information; and
a prediction unit configured to predict an operation to be executed on the electronic file based on the electronic file information, the operations history information, and the weight factors.

2. The information processing device as claimed in claim 1, further comprising:
a selection unit configured to select one of the electronic files to be operated.

3. The information processing device as claimed in claim 1, wherein each of the electronic files is assigned a unique electronic file ID.

4. The information processing device as claimed in claim 1, further comprising:
an electronic file information storage unit configured to store the electronic file information.

5. The information processing device as claimed it claim 3, wherein the operations history information is in connection with the electronic file ID.

6. The information processing device as claimed in claim 1, further comprising:
an operations history information storage unit configured to store the operations history information.

7. The information processing device as claimed in claim 1, further comprising:
a weight factor storage unit configured to store the weight factors assigned to the parameters.

8. The information processing device as claimed in claim 7, wherein each of the weight factors is assigned to the corresponding parameters.

9. The information processing device as claimed in claim 1, wherein the prediction unit comprises:
a quantification unit configured to quantify, relative to each of the parameters, relations between the selected electronic file and electronic files included in the operations history information based on the electronic file information;
a summation unit configured to sum the quantified relations with respect to each of electronic files having the same operations history information;
a product sum calculation unit configured to calculate a product of the summed quantified relations and the weight factor assigned to each of the parameters, and sum the products with respect to each of the operations in the operations history information; and
an operation extraction unit configured to extract a predetermined number of operations executed on the electronic file based on the sum of products results.

10. The information processing device as claimed in claim 9, further comprising:
a display unit configured to display the extracted operations.

11. The information processing device as claimed in claim 9, further comprising:
a parameter updating unit configured to update, when operations on the selected electronic file are detected, the weight factors according to the detected operations and a predetermined rule.

12. An information processing method, comprising the steps of:
acquiring information of an electronic file when the electronic file is selected from a plurality of electronic files;
acquiring operations history information including information of operations previously performed on the electronic file;
acquiring weight factors assigned to a plurality of parameters of the electronic file information; and
predicting an operation to be executed on the electronic file based on the electronic file information, the operations history information, and the weight factors.

13. The method as claimed in claim 12, wherein the step of predicting comprises the steps of:
quantifying, relative to each of the parameters, relations between the selected electronic file and electronic files included in the operations history information based on the electronic file information;
summing the quantified relations with respect to each of electronic files having the same operation in the operations history information;
calculating a product of the summed quantified relations and the weight factors assigned to each of the parameters, and summing the products with respect to each of the operations in the operations history information; and
extracting a predetermined number of operations executed on the electronic file based on the sum of products results.

14. The method as claimed in claim 13, further comprising the step of:
updating, when operations on the selected electronic file are detected, the weight factors according to the detected operations and a predetermined rule.

15. A program product including a program executable in an information processing device for performing information processing, said program driving the information processing device to carry out the steps of:
acquiring information of an electronic file when the electronic file is selected from a plurality of electronic files;
acquiring operations history information including information of operations previously performed on the electronic file;
acquiring weight factors assigned to a plurality of parameters of the electronic file information; and
predicting an operation to be executed on the electronic file based on the electronic file information, the operations history information, and the weight factors.

16. The program product as claimed in claim 15, wherein the step of predicting comprises the steps of:
quantifying, relative to each of the parameters, relations between the selected electronic file and electronic files included in the operations history information based on the electronic file information;
summing the quantified relations with respect to each of electronic files having the same operation in the operations history information;
calculating a product of the summed quantified relations and the weight factors assigned to each of the parameters, and summing the products with respect to each of the operations in the operations history information; and
extracting a predetermined number of operations executed on the electronic file based on the sum of products results.

17. The program product as claimed in claim 16, wherein said program further driving the information processing device to carry out the step of:
updating, when operations on the selected electronic file are detected, the weight factors according to the detected operations and a predetermined rule.
